(19) United States
(12) Patent Application Publication
(10) Pub. No.: US 2023/0419695 A1
(43) Pub. Date: Dec. 28, 2023

(54) ARTIFICIAL INTELLIGENCE (AI) ASSISTED ANALYSIS OF ELECTRON MICROSCOPE DATA

(71) Applicant: Battelle Memorial Institute, Richland, WA (US)

(72) Inventors: Sarah M. Akers, Richland, WA (US); Steven R. Spurgeon, Richland, WA (US)

(73) Assignee: Battelle Memorial Institute, Richland, WA (US)

(21) Appl. No.: 18/030,166

(22) PCT Filed: Oct. 8, 2021
(86) PCT No.: PCT/US2021/054308

§ 371 Date: Apr. 4, 2023

Related U.S. Application Data
(60) Provisional application No. 63/089,080, filed on Oct. 8, 2020.

(51) Int. Cl. G06V 20/69; G06V 10/82

(52) U.S. Cl. CPC G06V 20/698; G06V 20/695; G06V 10/82

(57) ABSTRACT

A computer-implemented method, includes (i) sectioning at least a portion of a real data set of interest into a grid of chips, each chip comprising a real data subset of the portion of the real data set of interest, and receiving a few user-selected chips corresponding to ground truth examples selected from the portion of the real data set, wherein the selected chips define a support set for a few-shot class prototype, (ii) encoding a latent space representation of the support set using an embedding neural network, and defining the few-shot class prototype as a mean vector of the latent space representation of the support set, and (iii) using the embedding neural network, encoding a latent space representation of other chips of the real set data of interest, and, using a few-shot neural network, comparing the latent space representation of the other chips to the few-shot class prototype and assigning few-shot class prototype labels to the other chips based on the comparison to identify features in the real data set of interest that are similar to the few user-selected chips.

### CROSS REFERENCE TO RELATED APPLICATION

This application claims the benefit of the earlier filing date of U.S. provisional patent application No. 63/089,080, filed Oct. 8, 2020, which is incorporated herein by reference in its entirety.

### FIELD

The field is data analysis.

### ACKNOWLEDGMENT OF GOVERNMENT SUPPORT

This invention was made with Government support under Contract DE-AC0576RL01830 awarded by the U.S. Department of Energy. The Government has certain rights in the invention.

### BACKGROUND

Microscope instrument operators will often use a-priori knowledge of a material, inspect particular features of image sets or spectroscopic sets, and then try to construct a model describing the starting material based off that a-priori knowledge and the features found in the data. However, electron microscopes and other instruments can generate information at an immense scale, e.g., images collected at thousands of frames per second, leading a human operator with no practical way to manually pick out features in the data.

Artificial intelligence (AI) promises to reshape scientific inquiry and enable breakthrough discoveries in areas such as energy storage, quantum computing, and biomedicine. Electron microscopy, a cornerstone in the study of chemical and materials systems, stands to benefit greatly from AI-driven automation. Many approaches in computer vision and AI that can be used to more automatically analyze features in images. Just as features in a human image might include faces, eyes, mouth, proportions between them, etc., and can provide details or signatures of a person, microscopic materials can also be rich with features, such as grain boundaries, defects, atomic motifs, at a local scale, as an ensemble, etc., and can be used to identify a material. Many computer vision approaches can work well but often require labor intensive steps to tune limiting their ability to scale to large amounts of data or noisy data.

Thus, present barriers to low-level instrumental control and generalizable feature detection make truly automated microscopy impractical. Consequently, a need remains for improved AI-driven tools in electron microscopy and other areas that can benefit from such tools.

### SUMMARY

Disclosed data analysis tools can provide a flexible pipeline for artificial intelligence (AI) assisted analysis of data collected from an electron microscope or other instruments. In some examples, near real-time image quantification results can be provided during data collection, and further examples can incorporate feedback from a user to tune performance, including during data collection. Disclosed methodologies supporting the tools apply few-shot machine learning techniques that leverage high fidelity million parameter deep learning models across disparate data without heavy compute costs and with very few data points.

Disclosed examples can also include closed-loop instrument control platforms guided by emerging sparse data analytics, such as disclosed few-shot analysis techniques. Centralized controllers, informed by machine learning based on limited a-priori knowledge, can drive on-the-fly experimental decision-making. Disclosed platforms can enable practical, automated analysis of a range of systems, and set the stage for new high-throughput and statistical studies.

In some examples, analytical software can perform in parallel with an instrument automation platform, e.g., by accommodating specific application-driven feature recognition and classification routines on-the-fly to support decision making during data collection. For example, with microscopes able to inspect a wide variety of samples, disclosed tools can include high-fidelity machine learning models that can generalize to new samples without requiring millions of training data points and hours of GPU compute time to retrain. By leveraging the practice of few-shot learning, where small amounts of training data are used to generalize large, pretrained deep learning models for new tasks. Herein, deep learning generally refers to artificial neural networks comprising multiple network layers. Disclosed few-shot approaches allow for model inference in near real-time, with the ability to generalize to completely new samples without the time and data requirements of traditional deep learning methods. This can provide microscopists and other instrument users with information about their sample as the data are being collected, which can guide decisions about which regions of the sample to subsequently image or acquire data from using the microscope or other instrument.

While disclosed techniques can be particularly applicable to real-time microscopy experiments, they also can be useful in numerous other instruments and applications. Some examples can be applied to biological instruments and applications, including cryoelectron microsopes (Cryo-EM). Disclosed techniques can be implemented in or coupled to SerialEM and LEGINON software packages for automated data acquisition and CryoSPARC, IMAGIC, RELION, and a host of other commercial and open source software tools for segmentation and reconstruction postprocessing. Biological experiments can specifically benefit from disclosed data classification tools that can be customizable for screening any number of different types of features, for particle counting, and for general feature classification that can be platform agnostic. Many examples can be applied in the materials science field, such as with optical microscopes, electron microscopes (e.g., TEM, SEM, STEM), focused ion beam instruments, and spectroscopy instruments. There is an immediate need for automated mapping of phases and microstructures, particle counting, k-space navigation, montage generation, physical/chemical tracking of dynamic processes, and more. Disclosed examples are not only applicable to research groups in universities and national laboratories that discover and harness new properties of matter, but also to industrial processes such as the in the silicon device industry which relies heavily on TEM data as a quality control metric.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1A is a screenshot of an example user interface of a data acquisition application which also displays few-shot machine learning classifications post-experiment or during the experiment as received from a linked few-shot machine learning application.

FIG. 1B is an expanded view of an automation script portion of the screenshot of the user interface in FIG. 1A.

FIG. 2 is a series of screenshots showing an example class prototype selection through a graphical user interface and associated segmentation statistics.

FIGS. 3A-3E shows series of images and schematics of an example few-shot method of image segmentation. A raw STO/Ge image shown in FIG. 3A is sectioned into several smaller chips shown in FIG. 3B. FIG. 3C shows how a few user selected chips from FIG. 3B are used to represent desired segmentation classes in the support sets. As shown in FIG. 3D, each chip from FIG. 3B can then act as a query and is compared against a prototype from FIG. 3C as defined by the support sets, and categorized according to a minimum Euclidean distance between the query and each prototype. The image from FIG. 3A segmented through FIGS. 3B-3D is shown in FIG. 3E.

FIGS. 4A-4C each shows a pair of original and segmented image, illustrating segmentation performance for three oxide systems.

FIG. 5 are segmented image results according to various segmentation approaches.

FIG. 6 is a flowchart of an example method of few-shot machine learning image segmentation.

FIG. 7 is a schematic of an example multi-level operation system for an electron microscope.

FIG. 8 is a flowchart schematic of an automation system with open-loop and closed-loop control modes.

FIG. 9 is a flowchart schematic of an example montaging method.

FIG. 10 is schematic of an example cloud computing environment that can be used in conjunction with the technologies described herein.

FIG. 11 is a schematic of an example computing system in which some described examples can be implemented.

### DETAILED DESCRIPTION

### Introduction and Overview

Disclosed examples include automated electron microscope data collection, triaging, and classification platforms. Machine-learning based automation can provide for unattended, batch data collection, triaging, and classification in electron microscopes and other instruments. Electron microscopy is useful in materials characterization, informing development and discovery in catalysis, energy storage, and quantum information science, by way of example. However, until now data collection in the microscope has been highly manual, inefficient, and subjective, motivating the need for new tools for more reliable, high-throughput automation and analysis. Disclosed examples use microscope control, automated data collection, and few-shot machine learning (ML) analysis. The articles “Rapid and Flexible Semantic Segmentation of Electron Microscopy Data Using Few-Shot Machine Learning” by Akers et al. (doi:10.21203/rs.3.rs-346102/v1), “Design of a Graphical User Interface for Few-Shot Machine Learning Classification of Electron Microscopy Data” by Doty et al, (arXiv:2107.10387), and “An Automated Scanning Transmission Electron Microscope Guided by Sparse Data Analytics” by Olszta et al. (arXiv:2109.14772v1) are incorporated by reference herein.

Graphical computer applications and back-end code can be used to automate the process of electron microscope data collection, metadata building, and analysis. In some examples, software programs implement Python based (or another computer software language) plugins configured to directly control the microscope with minimal human intervention. Automation application examples can interface with or link to a separate application for ML-based data triaging and classification. Automation application examples can multiply throughput and effectiveness of electron microscopy research and allow for more rigorous and statistically-sound analysis of materials chemistry and defects in energy materials, such as batteries and catalysts. Microstructural analyses of materials can improve, e.g., analysis of the nuclear fuel cycle.

Many modern technologies, such as computers and batteries, depend on intricate engineering of chemistry and defects at the nanoscale, which can be uniquely examined using transmission electron microscopy (TEM). However, antiquated models of microscope operation generally limit data collection, data triaging, and data classification. For example, during data collection, movement stages, cameras, and detectors are manually operated to acquire data. Such manual acquisitions are physically limited by available human focus and human time constraints precluding running microscopes for extended periods, decreasing productivity and sample throughput. With data triaging, selection of regions of interest is typically based on an operator's prior knowledge which tends to focus on what is already expected to be found, overlooking novel features and reinforcing existing biases. For data classification, integration of data streams is often limited by human cognition, which cannot easily evaluate higher-dimensional correlations between very different types of data (e.g., images and spectra, or across imaging modalities). Subtle, unexpected correlations between features are often overlooked which can impact material properties and experiment conclusions.

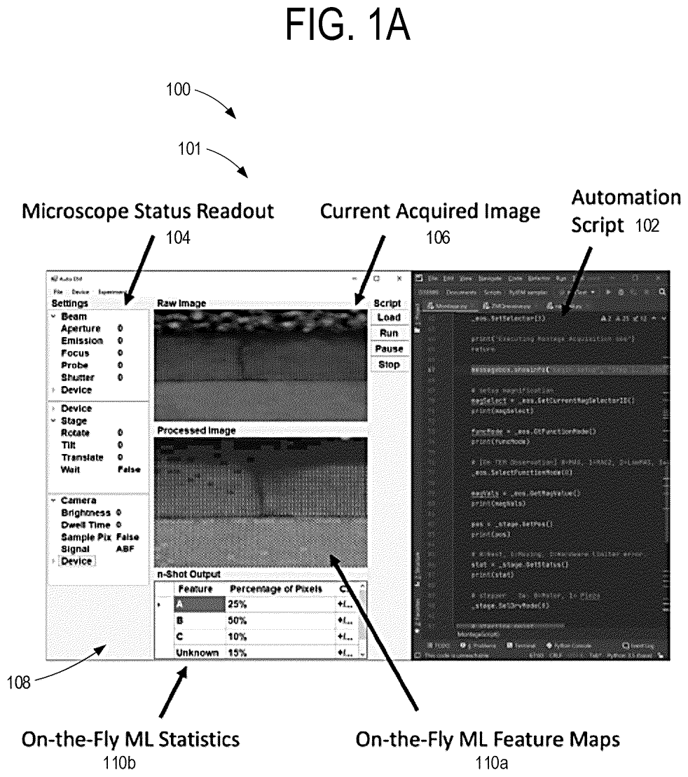

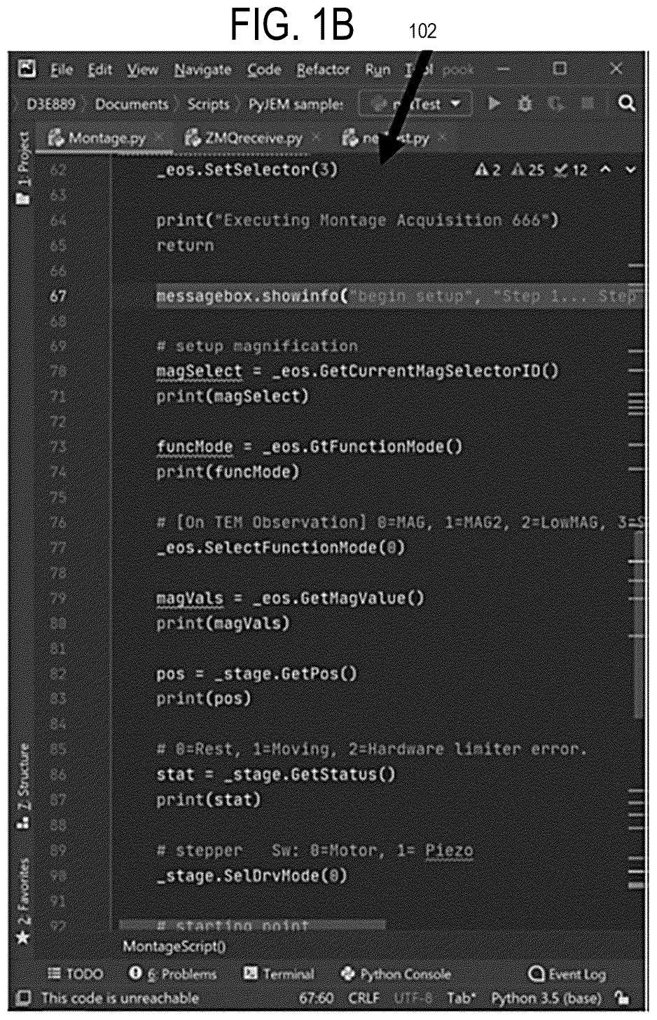

Suitable frameworks for data management and microscope communication can be flexibly based and extendible to accommodate an array of existing and future analysis modules, microscope features, and instruments, such as spectrometers and detectors. In a selected example, a PyJEM plugin was configured to send live commands to a JEOL GrandARM TEM in RPL. Automation application examples can be configured with graphical user interfaces (GUI) through various operating systems, such as Windows OS, and can include a .NET framework for the user interface and configuration, and a Python script engine for experiment design and hardware control. FIGS. 1A-1B show a screenshot 100 of a user interface 101 for an example data acquisition application. The application includes an editable script 102 (also shown in more detail in FIG. 1B) configured to control TEM data acquisition parameters. The application also includes a live microscope status readout 104 and a current acquired image 106. The user interface 101 also includes on-the-fly processed data section 108 from a separate few-shot machine learning application, showing highlighted features 110a and statistics 110b in near real-time during the data acquisition process. In various examples, the automation can be paused, aborted, and/or adjusted at any time.

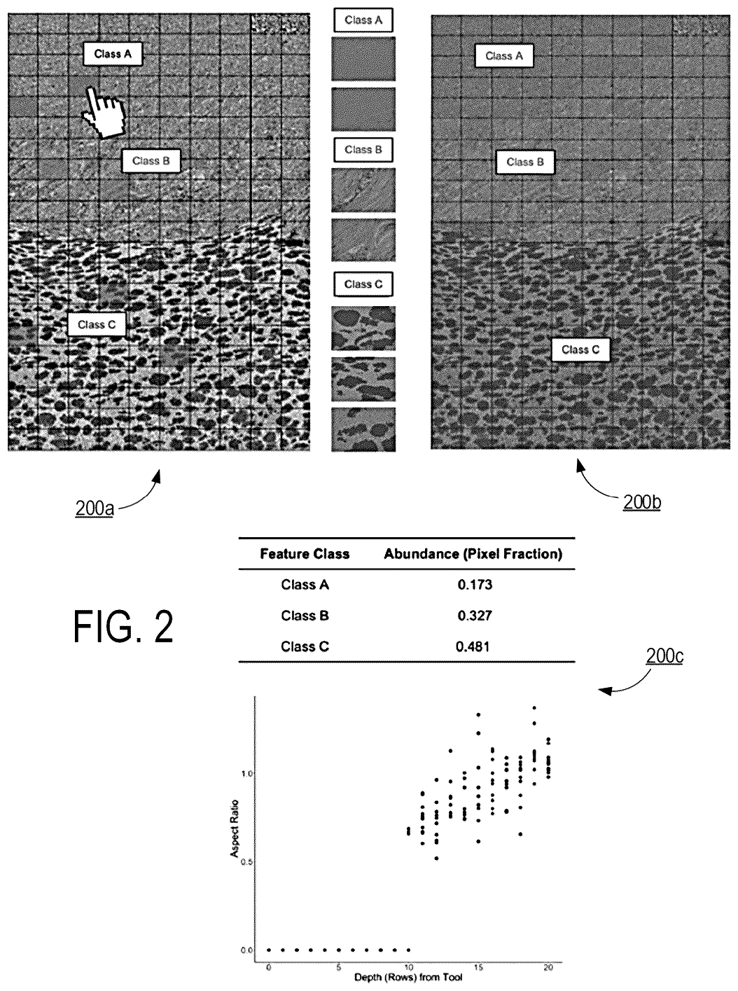

In parallel to the application configured for data acquisition and automation, the few-shot machine learning application is configured to provide ML image analysis and supply data to the example user interface 101. In some examples the few-shot application can be configured for particle or other feature detection and is customizable by the user through chip selection process used to generate support sets for class prototypes. FIG. 2 shows an example series of screenshots 200a, 200b, 200c showing a stepwise progression of support set selection, classified application outputs, and statistical display of classifications. The code can be configured to quickly identify features using only a handful of user-labeled images. For example, in screenshot 200a, a generalized network is being customized by a user selecting a few rectangles of an image corresponding to different classes (Classes A, B, and C). In screen shot 200b, after training a few-shot network to form class prototypes, a neural network classifies the other rectangles in the image based on the user-defined few-shot prototypes, propagating class selections across the entire image and subsequent images. In screen shot 200c, rich and repeatable statistics are gathers across many images either after data collection or on-the-fly during data collection. In some examples, support sets can be defined for two particle detection use cases or detection of specific particle features (position, spatial distribution, size distribution, etc.). In further test examples, two commercial standard samples were tested: Au nanoparticles on a carbon support film and MoO3 nanoparticles on a carbon support film. In a particular experiment, 10-50 STEM annular dark field images were collected at various magnifications to provide testing data for the effectiveness of the machine learning code and the application user interface.

Selected examples can be used for semantic segmentation of key microstructural features in atomic-scale electron micro-scope images, which can improve understanding of structure-property relationships in many important materials and chemical systems. However, the disclosed few-shot approach can improve over the present paradigm which involves time-intensive manual analysis that is inherently biased, error-prone, and unable to accommodate the large volumes of data produced by modem instrumentation. While more automated approaches have been proposed, many are not robust to a high variety of data, and do not generalize well to diverse microstructural features and material systems. Selected test examples disclosed herein demonstrate this robustness, using a flexible, semi-supervised few-shot machine learning approach for semantic segmentation of scanning transmission electron microscopy images of three oxide material systems: (1) epitaxial heterostructures of SrTiO3/Ge, (2) La0.8Sr0.2FeO3 thin films, and (3) MoO3 nanoparticles. The disclosed the few-shot learning techniques are more robust against noise, more reconfigurable, and require less data than other image analysis methods. Disclosed examples can enable rapid image classification and microstructural feature mapping needed for emerging high-throughput and autonomous microscope platforms.

### Discussion of Few-Shot Machine Learning

### I. Introduction

Material microstructures govern the functionality of many important technologies, including catalysts, energy storage devices, and emerging quantum computing architectures. Scanning transmission electron microscopy (STEM) has long served as a foundational tool to study microstructures because of its ability to simultaneously resolve structure, chemistry, and defects with atomic-scale resolution for a range of materials classes. STEM has helped elucidate the nature of microstructural features ranging from complex dislocation networks to secondary phases and point defects, leading to refined structure-property models. Traditionally, STEM images have been analyzed by a domain expert manually or semi-automatically, utilizing a priori knowledge of the system to identify known and unknown features. While this approach is suitable for measuring a limited number of features for small data volumes, it is impractical for samples possessing high density, rare, or noisy features. Moreover, manual approaches are difficult to scale to include multiple data modalities and cannot be performed at high speed, hindering the ability to perform in situ and complementary or correlative studies harnessing the full potential of modern instruments. At a more fundamental level, variability in how such measurements are conducted and a lack of standardized approaches contributes to the broader issue of reproducibility in experimentation. Though such limitations tend to apply to all materials classes, they are particularly pronounced for complex oxides, whose properties are heavily influenced by even trace amounts of unwanted defects. Disclosed examples address an urgent need for approaches to characterize microstructural features with greater accuracy, speed, and statistical rigor than is possible with existing methodologies.

A central challenge in quantitatively describing microscopy image data (e.g., micrographs) is the wide variety of possible microstructural features and data modalities. For example, the same instrument that is used to examine interfaces at atomic-resolution in one session may be used to examine particle morphology or grain boundary distributions at lower magnification the next. In each study, the goal is often to extract quantitative and semantically-meaningful microstructural descriptors to link measurements to underlying physical models. For example, estimating the area fraction of a specific phase or abundance of a feature through image segmentation is an important part of understanding synthesis products and phase transformation kinetics. Although several image segmentation methods exist (e.g., Otsu, the water-shed algorithm, k-means clustering), none is easily generalizable to different material systems, image types, and may require significant tailored image preprocessing.

Machine learning (ML) methods, specifically convolutional neural networks (CNNs), have recently been adopted for the recognition and characterization of microstructural data across length scales. Classification tasks have been performed to either assign a label to an entire image that represents a material or microstructure class (e.g., “dendritic,” “equiaxed,” etc.), or to assign a label to each pixel in the image so that they are classified into discrete categories. The latter classification type is segmentation of an image to identify local features (e.g., line defects, phases, crystal structures), referred to as semantic segmentation. However, many challenges remain in the practical application of semantic segmentation methods, such as the large data set size required for training a CNN and the difficulty of developing methods that are generalizable to a wide variety of data. Typically, data analysis via deep learning methods requires large amounts of labeled training data (such as the large image data set available through the ImageNet database). The ability to analyze data sets on the basis of limited training data, as often encountered in microscopy but also can be applicable to other technical fields in which data is collected, is an important frontier in materials and data science. Recent advances have led to developments that allow human-level performance in one-shot, or few-shot learning problems, but there are limited studies on such methods in the materials science and other relevant data collection domains. While many characterization tools may provide just a few data points, a single electron micrograph (and potentially additional imaging/spectral channels) may encompass many microstructural features of interest. Disclosed few-shot examples also have significant application to the study of transient or unstable materials, as well as those where limited samples are available for analysis due to long lead-time experimentation (such as corrosion or neutron irradiation studies). In other cases, there exists data from previous studies that may be very limited or poorly understood, for which advanced data analysis methods could be applied.

Disclosed examples provide rapid and flexible approaches to recognition and segmentation of STEM images, images from other instruments, and other data modalities, using few-shot machine learning. In selected demonstration examples, three oxide materials systems were selected for model development (epitaxial heterostructures of SrTiO3 (STO)/Ge, La0.8Sr0.2FeO3 (LSFO) thin films, and MoO3 nanoparticles) due to the range of microstructural features they possess, and their importance in semiconductor, spintronic, and catalysis applications. With only 5-8 sub-images (termed chips) that represent examples of a specific microstructural feature (e.g., a crystal motif or particular particle morphology), disclosed models yielded segmentation results comparable to those produced by a domain expert. The successful image mapping can be attributed to the low noise sensitivity and high learning capability of few-shot machine learning in comparison to other segmentation methods (e.g., Otsu thresholding, watershed, k-means clustering, etc.). The few-shot approaches rapidly identified varying microstructural features across STEM data streams, which can inform real-time image data collection and analysis, and underscore the power of image-driven machine learning to enable improved microstructural characterization for materials discovery and design.

### II. Results and Discussion

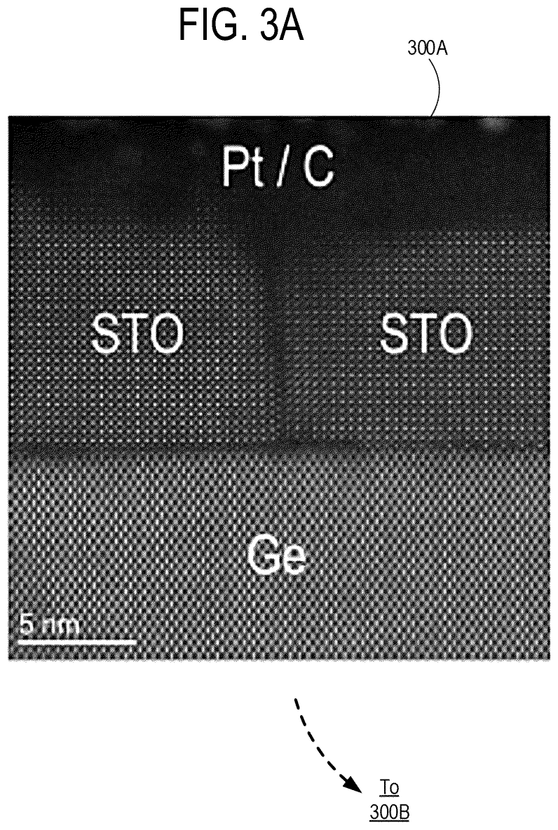

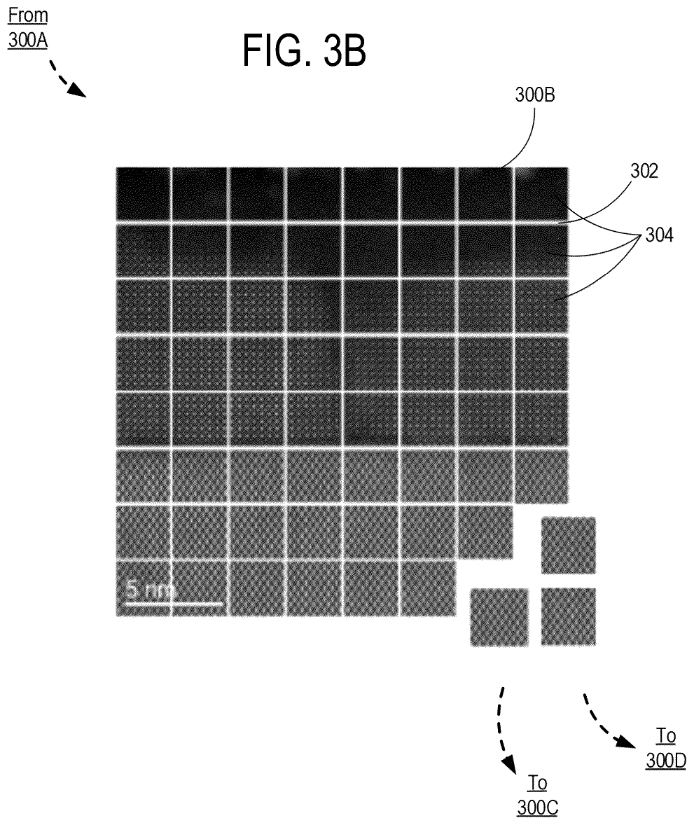

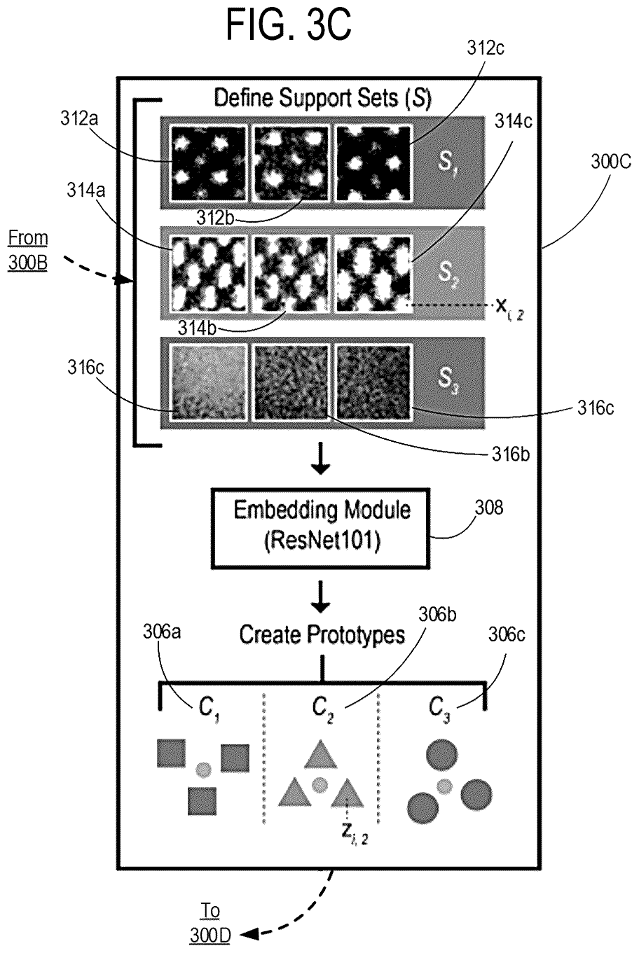

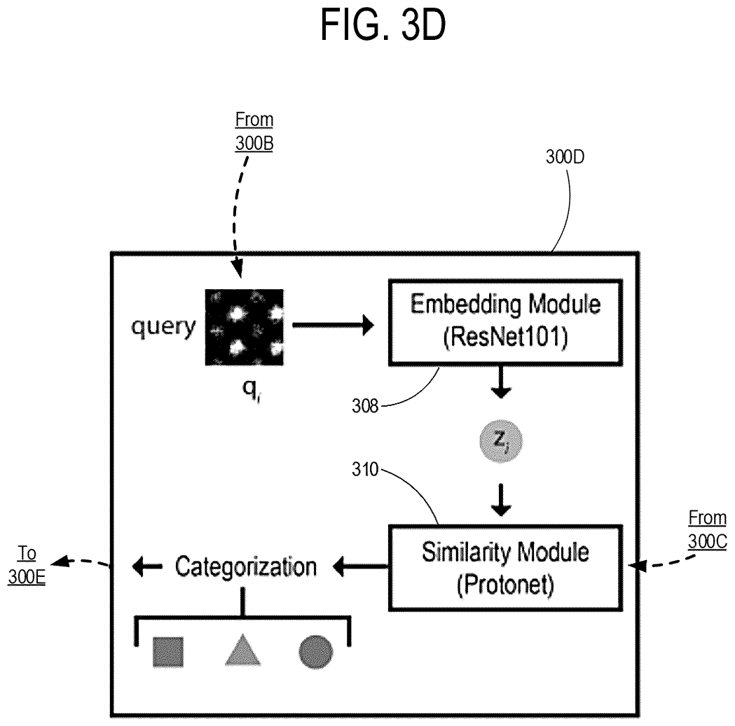

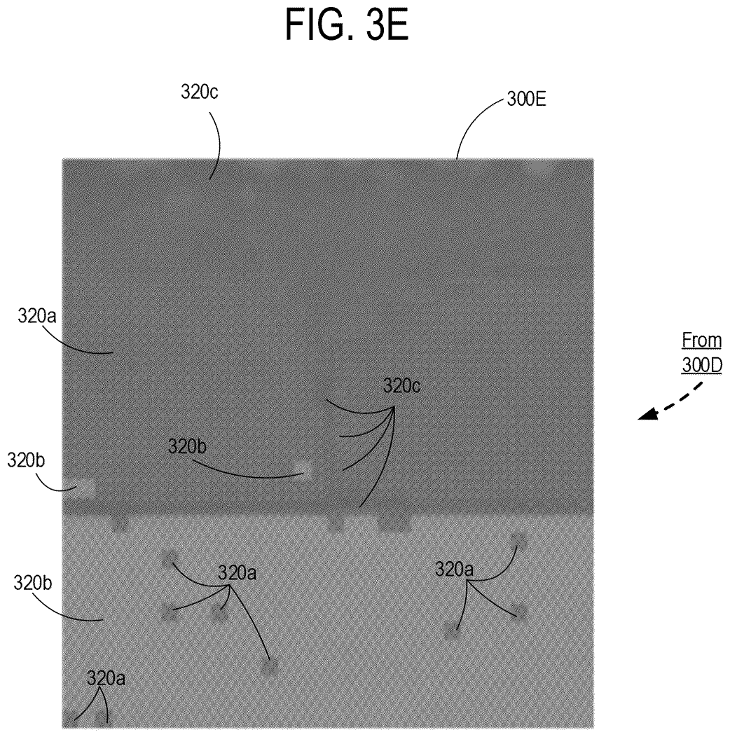

FIGS. 3A-3E depict an example few-shot deep learning approach configured to provide semantic segmentation of STEM images and is shown through an interrelated series of images and schematics 300A-300E. In representative examples, few-shot learning models can use very few labeled examples (e.g., ≤2, ≤3, ≤5, ≤10, etc.) per class for a particular model to identify regions of an image that correspond to each class. As can be seen in FIG. 3A, data from one or more detection modalities is provided, e.g., in the form of a microscope image 300A. The image 300A forms an input image that is sectioned into a grid 302 of sub-images 304, as shown in sectioned image 300B in FIG. 3B, and the sub-images 304 can be referred to herein as chips. FIG. 3C shows a model initialization schematic 300C that uses selections of sub-images 304 from the sectioned image 300B to produce class prototypes 306a-306c. FIG. 3D shows a model inference schematic 300D configured to produce a classification for sub-images 304 of the sectioned image 300B or other images and sub-images, and FIG. 3E illustrates a segmented micrograph output 300E from the model inference. In many examples, the process of sectioning, or chipping, can be enhanced by domain-specific knowledge of the materials microstructure, e.g., as indicated in the annotations in FIG. 3A showing areas of different material types Pt/C, STO, and Ge.

A. Preprocessing

To separate and measure distinct phases of a material, with the phases having varying contrast in the STEM images, preprocessing of original image data can be performed in some examples. In the experimental example shown in FIGS. 3A-3E, a histogram equalization (HE) technique designed to enhance local image qualities without introducing global artifacts, termed contrast limited adaptive HE (CLAHE), was selected for use. The details of the CLAHE implementation are described in Table I.

TABLE I
Image preprocessing parameters listed by material system and
task with respective libraries/methods for implementation.

| | | Material System | | |
|---|---|---|---|---|
| Task | Method/Library | LSFO | STO/Ge | MoO₃ |
| Image Reading | cv2.imread | flag = 0 (grayscale) | flag = 0 (grayscale) | flag = 0 (grayscale) |
| Equalization | CLAHE | clipLimit = 2.0, | clipLimit = 2.0, | clipLimit = 2.0, |
| | | tileGridSize = (8, 8) | tileGridSize = (8, 8) | tileGridSize = (8, 8) |
| Chipping | image slicer | tiles = 500 | tiles = 1000 | tiles = 256 |
| Resizing (pixels) | ResNet | 256 × 256 | 256 × 256 | 256 × 256 |
| LoG | skimage | max_sigma = 30, | N/A | N/A |
| | | num_sigma = 8, threshold = 0.1 | | |

CLAHE was first performed on original images and then the processed image was sectioned into a set of smaller sub-images 304, as shown in FIG. 3B. The chip size varied between 95×95 pixels and 32×32 pixels, however all chips were resized to 256×256 in the later model inference embedding module (here the readily available ResNet101 CNN). The variable size allowed for each chip to be large enough to capture a microstructural motif and small enough to provide granularity between adjoining spatial regions, as can be seen in FIGS. 3A-3B. It will be appreciated that in various examples a variety of sub-image shapes and/or sectioning characteristics may be used, e.g., shapes such as square, rectangular, hexagonal, circular, etc., and characteristics such as contiguous, spaced, overlapping, etc. In the experiment, a final preprocessing step used was an enhancement technique that marks the position and size of atomic columns using a Laplacian of Gaussians (LoG) blob detection routine. This step was used on the LSFO material system to enhance extremely subtle differences between classes.

B. Model Architecture

The few-shot model shown in FIGS. 3A-3E includes an embedding module 308 including a convolutional neural network (e.g., ResNet101), and a few-shot similarity module 310 including a few-shot neural network (e.g., ProtoNet). The few-shot model inputs the preprocessed STEM image 300A, typically with high resolution on the order of 3000×3000 pixels, that has been broken down (as shown in sectioned image 300B) into a series of smaller chips, xᵢₖ, not larger than 100 by 100 pixels in some examples. A few of these chips are used as examples, or a support set, to define each of one or several classes, as shown in schematic 300C. While other image applications that use few-shot learning typically use disparate xᵢₖ to define a support set for each class (Sₖ), in disclosed examples Sₖ can be created by breaking the original image 300A into a grid 302 of smaller sub-images 304. A subset of sub-images 304 wase labeled for each class, e.g., chips 312a-312c for support set S₁, chips 314a-14c for support set S₂, and chips 316a-316c for support S₃. The set of N labeled examples for k=1, . . . , K classes makes up the support set defined by: S={(x₁, y₁), . . . (x_{N}, y_{N})}, where xᵢ represents an image i and yᵢ is the corresponding true class label.

A Prototypical Network can be used for the similarity module 310 and can be advantageous given its lightweight design and simplicity. Disclosed few-shot models are based on the premise that each Sₖ may be represented by a single prototype, cₖ. To compute cₖ, each xᵢₖ is first processed through an embedding function ƒ_{φ} which maps a D-dimensional image into an M-dimensional representation through learnable parameters φ. The number of dimensions M can depend on the type or depth of encoding neural network. The transformed chips, or ƒφ(xᵢk)=zᵢₖ, then creates the prototype for class k (e.g., prototypes 306a-306c) as the mean vector of the embedded support points cₖ, as follows:

$${c}_{k} = \frac{1}{{N}_{{S}_{k}}} {\sum }_{( {z}_{i} , {y}_{i} ) ∈ {S}_{k}} {z}_{i}$$

After class prototypes are created through 300C, the similarity module 310 (e.g., an untrained Prototypical Network) classifies a new data point, or query qᵢ, by first transforming the query through the embedding function, e.g., through the embedding module 308, and then calculating a distance, e.g., Euclidean distance, between the embedded query vector and each of the class prototype vectors. After the distances are computed, a softmax normalizes the distance into class probabilities, where the class with the highest probability becomes the label for the query, as shown with the categorization step 318 in schematic 300D. The final output of the model, for each qᵢ, the respective class label, which can form the segmented image 300E. The segmented image 300E can be color-coded according to class labels, e.g., with colored chips 320a-320c corresponding to chips closest to respective prototypes 306a-306c or can be provided with another difference between classified chips for visual distinction by a user.

C. Model Inference

In order to quantify phase fractions in a STEM image (which can range from nm to μm in spatial dimension) each chip can be used as a query point, qᵢ, so that the entire set of query points, Q, can make up the full image. The size of Q is typically directly proportional to the size of each chip and the size of the full image, as shown in Table II.

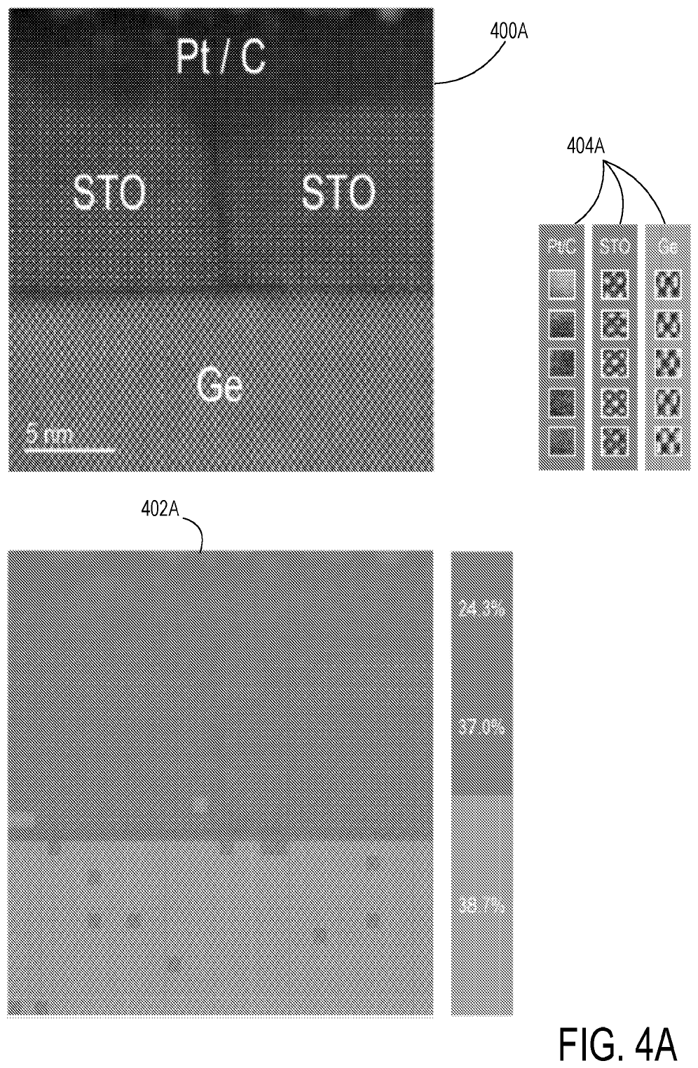

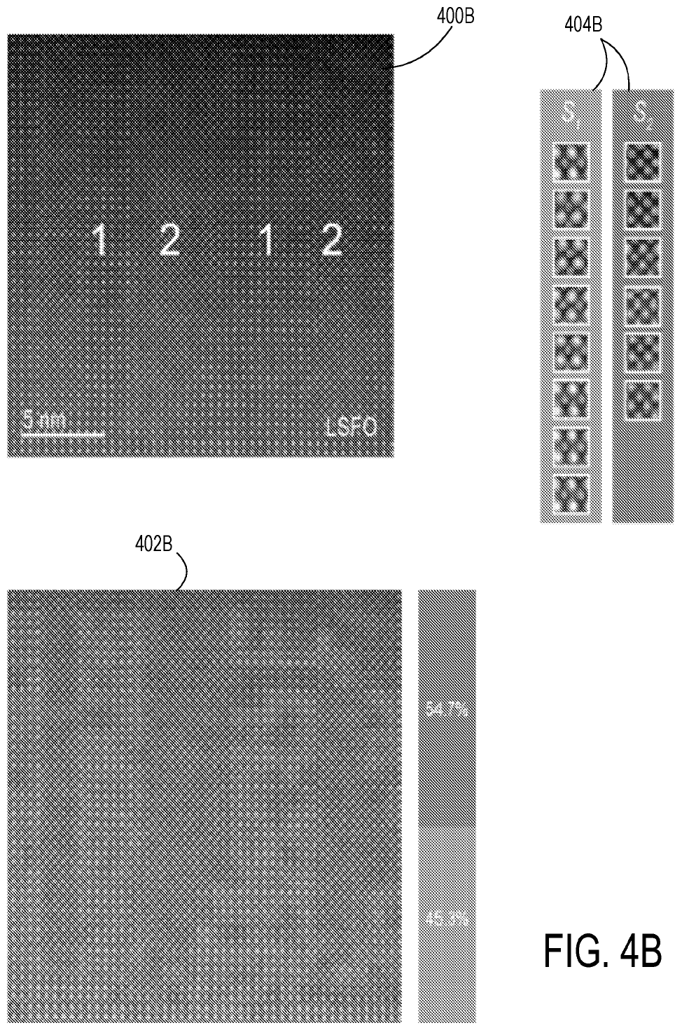

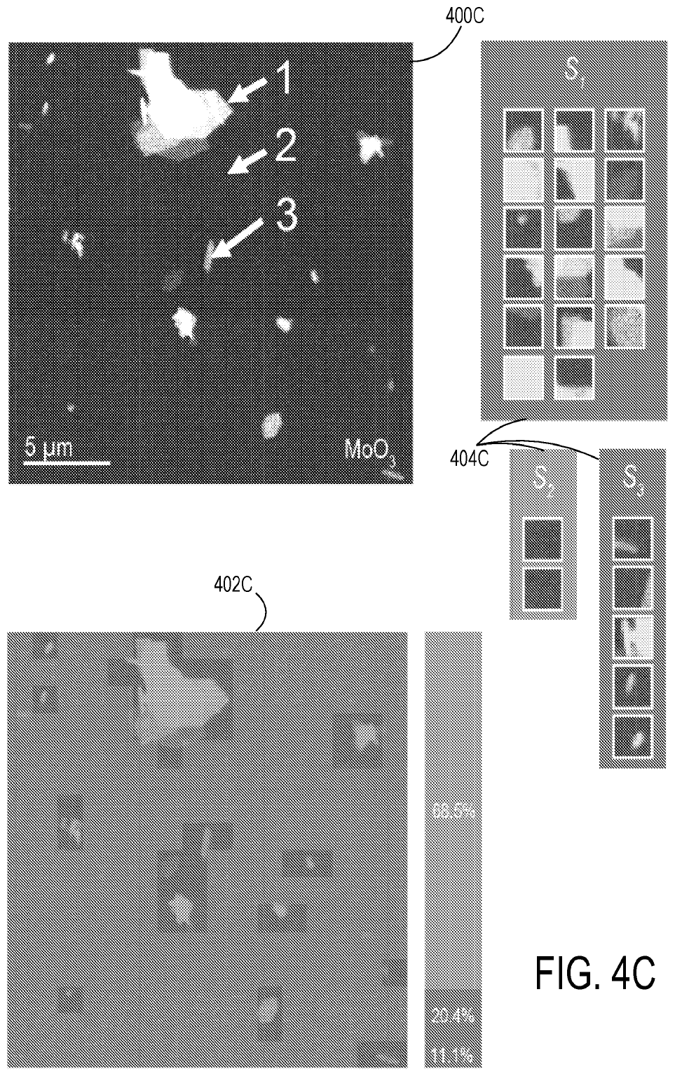

TABLE II
Few-shot specific implementation information including
model parameters, image information, and computing
device used for the images shown in FIG. 4.

| | Material System | | |
|---|---|---|---|
| Parameter | LSFO | STO/Ge | MoO₃ |
| Support | 2 | 3 | 3 |
| Classes | | | |
| Batch Size | 8 | 8 | 16 |
| Image Size | 2048 × 2048 | 3042 × 3044 | 512 × 512 |
| (pixels) | | | |
| Total Chips | 500 | 1000 | 256 |
| Chip Size | 34 × 35 | 95 × 95 | 32 × 32 |
| (pixels) | | | |
| Encoding | ResNet101 | ResNet101 | ResNet101 |
| | pretrained = True | pretrained = True | pretrained = True |
| Distance | Euclidean | Euclidean | Euclidean |
| Metric | | | |
| Similarity | Protonet | Protonet | Protonet |
| Module | | | |
| Computing | device = CPU | device = CPU | device = CPU |

In the example shown in FIG. 3A-3E, all qᵢ were first processed through the embedding function of the embedding module 308 and distances to each prototype 306a-306c were computed using the selected distance function. The few-shot network of the similarity module 310 then produced a distribution over each of the K classes by computing a softmax over the distances and assigning a class label according to the highest normalized value.

The model-specific implementation and parameters used in the specific example are provided in Table II, above. While the selection of model parameters in other machine learning approaches is often tedious, specific model parameters in the disclosed few-shot examples can be generally straightforward. For example, pretrained models can be leveraged as the architecture for the embedding module 308. In the example shown in FIGS. 3A-3E, a residual network with 101 layers, ResNet101, was used as the embedding architecture. ResNet was specifically selected given its success in several related image recognition tasks. Model weights for ResNet101 are available from PyTorch pytorch/vision v0.6.0, as trained on the image database ImageNet. Also, the Euclidean distance metric was used in the few-shot network, because this metric generally performs well across a wide variety of benchmark datasets and classification tasks. Pretrained models come with specified parameters and trained model weights. However, it should be noted that in many examples any embedding architecture may be used, especially those well-suited for segmentation tasks. In some examples, off-the-shelf neural networks without any known performance applicability to micrograph segmentations can be used. In further examples, even networks known to have poor segmentation performance with microscopy data or other instrument data can be used.

The similarity module 310 can be any few-shot or meta-learning architecture as well; however, Protonets are generally relatively simple and easy to implement. Parameters not necessarily specific to the models—namely chip size and batch size—can take the size of each distinct micrograph into consideration in addition to computational memory capacity. A chip should generally encompass a single micrograph and may take trial and error depending on the size of the full image and magnification. The batch size can be the number of chips to evaluate at once. Generally, a computing machine with at least 16 GB of RAM and 2.7 GHz of processing power can reasonably compute model predictions at a rate of about 1 chip per 0.5 seconds, with a batch size of 100 chips measuring 64×64 pixels. The compute time can depend on processing power in addition to the chip size and the number of parameters in the embedding module 308. In some examples, segmentation and related processing can be performed on a separate computing unit locally or through cloud-based resources. In the case of training a few-shot model, rather than simple inference as shown here, at least one GPU is necessary and may take several days to reach convergence given a sizeable database, e.g., a typical image database like ImageNet54 contains 14 million images. Thus, in representative examples discussed herein, untrained few-shot models are used and pure inference is used to make judgments about an image.

D. Classification

The segmentation output of few-shot classification using the Prototypical architecture for three oxide systems is shown in FIGS. 4A-4C. Input images 400A-400C and respective model outputs 402A-402C are superpixel classifications, i.e., every pixel that belongs to a chip receives the same label and corresponding color, much in the same way other computer vision applications approach segmentation. Here, the support set classes 404A-404C define the set of possible output labels. The percentage of chips belonging to each class, shown to the right of the respective output segmentations 402A-402C, can be scaled from percentages to area using pixel scale conversions for a total area estimate for each distinct micrograph.

The STO/Ge system presents a particular challenge for most image analysis techniques in that the contrast varies irregularly across the whole image. The sample also contains multiple interfaces and is representative of typical thin film-substrate imaging data. The selected LSFO image shows a secondary phase in the perovskite-structured matrix, and the secondary phase appears to have a gradient from top to bottom, which drastically diminishes the very subtle differences between the two micrographs. Separation of the two interpenetrating microstructural domains is necessary to understand the synthesis process and resulting properties, such as electrical conductivity. While preprocessing can adjust for some of these irregularities, traditional threshold-based segmentation techniques such as Otsu's Method, and watershedding, are not robust enough for a consistent solution. Further, even adaptive methods can fail against a gradient and certainly fail when applied generally across multiple images. While some irregularities do exist in the model outputs, e.g., where the secondary micrograph region in 402A contains a handful of misclassified chips, and some inconsistency in the LSFO system 402B in identifying some microstructural features (namely S₁), some examples can correct such types of issues with a post hoc spatial smoothing. For example, chips completely surrounded by one label within some radius can weight the class probability, or adjustments can be made to the selection of chips that define the support set. For example, variations to chip size, shape, and/or chips can be offset relative to data, and the the mesh can be tailored to reduce irregularities. Also, disclosed few-shot techniques can be easily generalizable to several different material systems, because a single support set defined by one image can be applied without adjustment to multiple images of the same type (e.g., other adjacent images, a time series of images, a different session of data collection with some common parameters such as magnification or numerical aperture, multi-modal relationships to other detection modalities, etc.) for an unmatched time savings in the analysis of image series. This ease of generalizability can be particularly advantageous in the case of large area mapping, as shown for the Mo₃ nanoparticles, where it can be necessary to collect image montages to survey the wide variety of possible particle morphologies. Here again disclosed few-shot methods successfully distinguish several nanoparticle orientations from the carbon support background, with minimal instances of inaccurate labeling. In particular, the few-shot approach accommodated the visual complexity of S₁ in 402C, with a range of shapes, contrast, and sizes defining this ‘flat’ category. While S₁ in 402C is defined with several more chips than the others, the model is able to reasonably perform a segmentation task that would be impossible for contrast-based methods alone. Thus, ability of the model to generalize well to different material systems is demonstrated in FIGS. 4A-4C, which shows that varying microstructural features were successfully mapped for STO, LSFO, and MoO₃.

E. Comparison to Other Methods

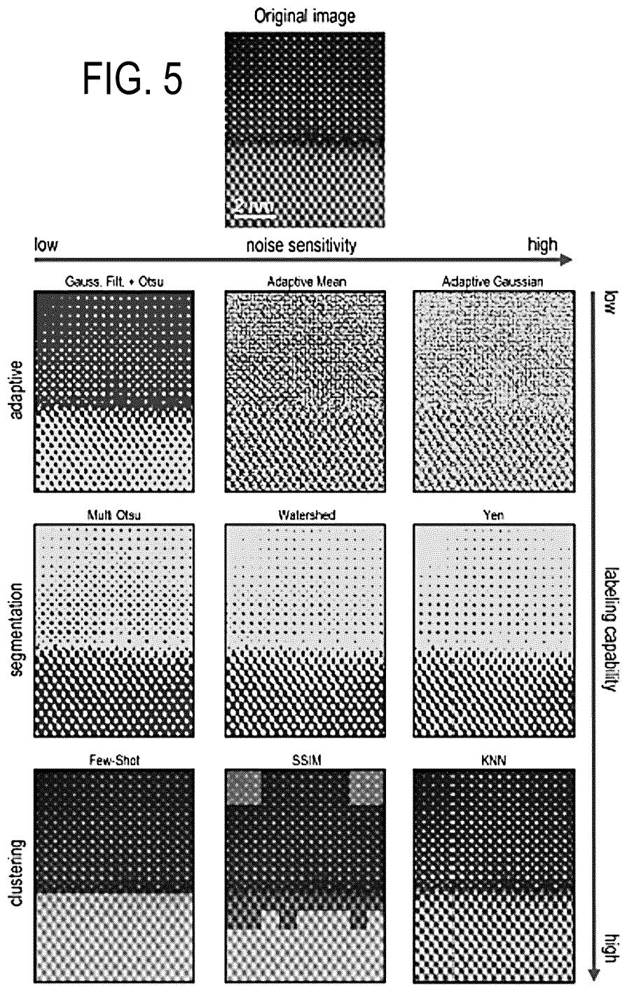

Initially, several image analysis techniques were explored in an effort to quantify microstructural features of interest in specific micrographs, i.e., segmentation. None of the single segmentation methods would perform well in the absence of preprocessing steps, such as contrast adjustments, smoothing, and sharpening. The aim of preprocessing in these analyses can be to globally minimize artificial contrast textures and locally emphasize object edges, which is an important noise reduction step for most segmentation routines. Given that preprocessing and segmentation are often inseparable, comparable segmentation methods were examined in the context of both segmentation and preprocessing together. In an effort to compare the few-shot approach with more widely used segmentation methods, an example image from the STO/Ge system was analyzed using techniques with varying noise sensitivity and segmentation capabilities, with results presented in FIG. 5.

The simplest approach to segmentation falls under a family of thresholding techniques shown in the first row of FIG. 5. The three methods of Gaussian fit+Otsu, Adaptive Mean, and Adaptive Gaussian shown in the top row are designed to separate pixels in an image into two or more classes, based on an intensity threshold. The threshold in these methods is determined using information about the distribution of pixel intensities either globally (top row left) or locally using a neighborhood of pixels (top row center and right). The neighborhood methods are commonly more sensitive to noise, while Otsu's more global technique appears to separate foreground pixels (light) from background (dark) relatively well.

Moving beyond simple thresholding, separating pixels into classes other than background and foreground can be examined The segmentation methods shown in FIG. 5 typically have the ability to separate intensities into multiple classes again defined by the distribution of pixel intensities in the image. Two classes are specified for these routines in order to demonstrate the premise that, ideally, the image could be segmented according to the two distinct micrographs. These approaches also typically involve blurring filters and/or morphological operations in order to remove pixels that are not a part of a larger group or shape. While shape edges are more defined in the Multi-Otsu, Watershed, and Yen approaches shown in the middle row of FIG. 5 than in the top row, the resulting segmentation still appears to be background/foreground and misses the distinction between micrograph structures. One limitation of a direct implementation of these methods is that the resulting classes will always be based on intensity and not on the size or shape of the underlying micrographs. It may be possible to layer these methods with a shape detection routine where shapes of approximately the same size may be clustered into the same class. However, it was found that clustering shapes post foreground/background segmentation was not able to distinctly separate microstructural features in an unsupervised manner, i.e., without tedious and manual intervention.

Rather than adding a shape clustering routine to an already segmented image, cluster-based methods were implemented on either the raw image, or neighborhoods of the raw image in the bottom row of FIG. 3. A common unsupervised K-Nearest Neighbors (KNN) clustering method is shown in the bottom row right, where clustering results are again seen based on pixel intensity or background/foreground separation. Bottom row middle shows the first non-intensity-based approach. An average structural similarity index measure (SSIM) is computed pairwise for 100×100 pixel non-overlapping neighborhoods as a measure of similarity between regions. The average SSIM for each neighborhood is a bimodal distribution that can be grouped into two classes as shown in bottom row center of FIG. 5. However, the cutoff in SSIM must be manually determined. Lastly, a few-shot segmentation according disclosed few-shot techniques manuscript is shown in bottom row left, where perfect segmentation between the two regions of distinct micrographs is seen. Few-shot has been included as a clustering technique because a neighborhood is compared to a prototype analogous in some respects to the way clustering techniques compare to a centroid.

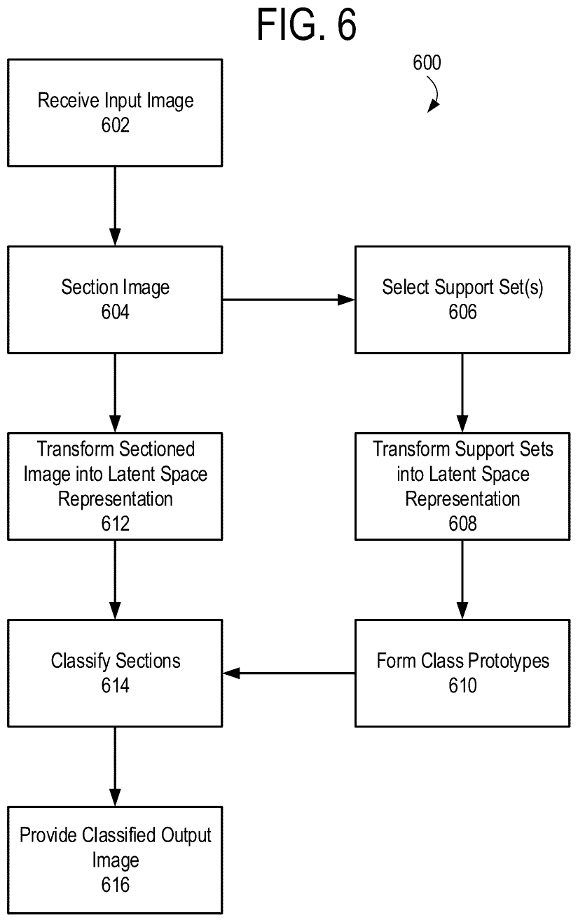

FIG. 6 shows a flowchart of another example few-shot method 600. At 600, an input data image is received from an instrument, such as an imaging or spectral sensor or another detector of a microscope or other instrument. At 604, the input data image is sectioned into an arrangement of smaller sub-images. At 606, a user can select support sets for few-shot image segmentation from the arrangement of smaller sub-images, by selecting various sub-images of interest representing different classes of features of interest, e.g., with a mouse or touchscreen interface. Support sets can include features selected by the user that is of interest. Support sets can also include regions that should be distinguished from features that are cared about, e.g., known background materials or objects, dark space, white space, certain textures or colors, specific materials or objects that are not interesting, etc. At 608, the support sets are transformed into a latent space representation by processing through an embedding neural network. At 610, class prototypes are formed that are to be subsequently used by a few-shot neural network to classify other sub-images of the arrangement or other sub-images in other acquired input data images. At 612, at the time the support sets are transformed at 608 or at a different time, the other sub-images of the input image or sub-images of other images are transformed into a latent space representation by processing through the embedding neural network. At 614, the sub-images of input data images are classified based on a comparison to the class prototypes and the different sub-images are assigned corresponding class prototype labels. At 616, a classified output image can be provided, e.g., by being stored in computer memory and/or by being displayed to a user.

As discussed, microscopes often include more than one detection modality, such as different detector channels, detectors configured to detect different particles, different orientations, different types of data, detectors with different parameter configurations such as gating, sampling rate, frame rate, etc. In some examples, few-shot support sets can be defined in multiple simultaneously-acquired (or non-simultaneous) data modalities. The multi-modal few-shot support sets can then be used to define a higher dimensional support set vector describing classes in the aggregate modalities. Queries classifying unknown multimodal data can then be performed against those higher dimensional support set vectors. For example, features that might have a higher class probability based on a support set defined for only one modality can have a different class probability due to the impact of other modalities. In some examples, support sets associated with a detection modality can produce classification labels for different chips that can be assigned to similar chips of data acquired through a second detection modality. For example, because the coordinates of classified chips can be known, a feature of interest can be mapped to images in the second detection modality to provide useful information to a user. In some examples, a user can select or deselect support sets in the first modality by reviewing the feature locations in the second modality to refine few-shot support sets. Further, support set selection in the second detection modality can be aided by the mapping of labels from the first detection modality. In some examples, support sets in the second detection modality can be automatically populated based on the classification labels generated for the first detection modality.

### III. Advantages and Applications

Disclosed examples using flexible few-shot learning approaches to STEM image segmentation can significantly accelerate mapping and identification of phases, defects, and other microstructural features of interest in comparison to more traditional image processing methods. Three different materials systems (STO/Ge, LSFO, and MoO₃) were used to verify performance, with varying atomic-scale features and hence diversity in image data for model development. Segmented images using disclosed few-shot learning approaches show good qualitative agreement with original micrographs.

When compared to other techniques, the noise sensitivity and/or labeling capability were found to remain challenges for adaptive segmentation and clustering algorithms. The few-shot techniques explored exhibited superior performance and remain flexible enough to accommodate a suite of materials. While few-shot machine learning has been increasingly successful in rapidly generalizing to new classification tasks containing only a few samples with supervised information, the empirical risk minimizer can be slightly unreliable, leading to uncertainty in the reliability of the model for any given support set. Some of this uncertainty can be mitigated with careful selection of the support set in order to avoid driving the model toward a non-optimal solution with mistakes in the support set, for instance. Another way some of the uncertainty in solutions can be reduced is to actually train the few-shot model with large volumes of labeled data, when available, so that new classification tasks already have the benefit of optimization, even in a completely new and different material systems. Spatial statistics may also provide a way for smoothing spurious segmentation predictions from an otherwise uniform material region. Aside from uncertainties in performance, the benefits in model generalizability also limit the amount of physically meaningful information that can be extracted from the model itself.

In some examples, disclosed few-shot examples can be applied to multiple data streams, such as spectral (electron energy loss spectroscopy (EELS) and energy-dispersive X-ray spectroscopy (EDS)), as well as diffraction (4D-STEM) in a multi-modal few-shot model. Insights in the multi-modal context would help to extract more physically meaningful information and likely enhance the segmentation performance.

In theory, this same model should generalize to a wide variety of STEM images and our preliminary results on other systems are indicative of this. Yet still unknown are the effects of the size and variety of the examples in a support set for a given class. Simulation studies are being designed to help answer these questions and more, including the possibility of using other models for embedding and the benefit of model training. Recent work in few-shot for texture segmentation61 also indicates that pixel level annotation may be possible, pushing the accuracy of this approach beyond chip-level resolution. Ideally, few-shot segmentation can also help curate and annotate these large training sets, something that is otherwise extremely costly to do manually and at scale. In summary, this approach offers a potentially powerful means to standardize and automate the analysis of materials microstructures for a single image, paving the way to new high-throughput characterization architectures.

### IV. Experimental Methods

The three experimental systems described above were prepared as follows. SrTiO3 films were deposited onto Ge substrates using molecular beam epitaxy (MBE). La0.8Sr0.2FeO3 films were deposited onto SrTiO3 (001) substrates using MBE. Cross-sectional STEM samples of the thin films were prepared using a FBI Helios NanoLab DualBeam Focused Ion Beam (FIB) microscope and a standard lift out procedure. Bulk MoO₃ particles were drop cast onto a lacey carbon grid from suspension in ethanol. High-angle annular dark field (STEM-HAADF) images of the STO/Ge were collected on a probe-corrected JEOL ARM-200CF microscope operating at 200 kV, with a convergence semi-angle of 20.6 mrad and a collection angle of 90-370 mrad. STEM-HAADF images of the LSFO and MoO3 were collected on a probe-corrected JEOL GrandARM-300F microscope operating at 300 kV, with a convergence semi-angle of 29.7 mrad and a collection angle of 75-515 mrad. The original image data analyzed in this work varied between 3042×3044 pixels (for STO/Ge), 2048×2048 (for LSFO), and 512×512 for MoO3. Because of its beam sensitivity, the STO/Ge images shown were collected using a frame-averaging approach; a series of 10 frames were acquired with a 1024×1024 px sampling and 2 μs px⁻¹, then non-rigid aligned and up-sampled 2× using the SmartAlign plugin. Tens of images were collected from each material system and a range of selected defect features were used in this study. The specific implementation of the preprocessing techniques and parameters for the few-shot model are described above in Tables I and II, respectively. All methods were implemented using the Python programming language v.3.6. Each image was processed using a 16 GB RAM 2.7 GHz Intel Core i7 MacBook Pro.

### Control and Automation System Examples

The history of science is punctuated by the development of tools, approaches, and protocols to more richly probe the natural world. Watershed discoveries have been directly linked to humanity's sophistication in designing and executing increasingly revealing experiments. The rise of clean energy the silicon revolution and designer medicine are just a few results of seeing the world through better spatial, chemical, and temporal lenses. Traditionally, manual approaches have kept pace with experimentation, but currently all scientific domains produce data at a scale and complexity far exceeding human cognition. This situation has yielded an ironic surplus of data and shortfall of immediately actionable knowledge, motivating the development of automation and artificial intelligence (AI) to transform experimentation. While some communities, such as chemical synthesis, crystallography, and biology were early adopters of this new paradigm, fields such as electron microscopy of hard matter have just begun this transition because of longstanding practical barriers. Some of these barriers, such as closed or proprietary instrumentation platforms, are the result of business drivers, while others stem from a lack of accessible, standards-based experiment frameworks. As a result, the adoption of data science in microscopy has been highly fragmented, with some institutions able to develop powerful custom instrumentation and analysis platforms, while others have been unable to integrate these practices into everyday analysis workflows. There is presently a great need to design a practical and generalizable automation platform to address common use cases.

Two important components of any automation platform are low-level instrument control and decision-making analytics. In the case of the former, researchers are typically forced to choose between accepting the control limitations set by manufacturers (often necessary to guarantee performance specifications) or designing a bespoke instrument. The community has developed multiple innovative approaches to high-throughput screening and automation most prominently in the fields of cell biology, medical diagnostics, and single-particle cryo-electron microscopy, but also in crystallography, semiconductor metrology, and particle analysis. More recently, manufacturers have begun to provide increased access to low-level instrument functions. These application programming interfaces (APIs) can potentially be integrated into existing machine learning (ML) pipelines and may enable new control frameworks, such as “measure-by-wire” auto-tuning and Gaussian-process-driven experimentation. However, because these APIs are in their incipient development phase and require programming, hardware, and microscopy expertise, few control systems have been designed to take advantage of them. Further complicating the situation, modern instruments often incorporate components from different manufacturers (e.g., cameras, spectrometers, and scan generators), whose lack of feature and access parity complicate any “open controller” design. An ideal “open controller” should (1) serve as a central communications hub for low-level instrument commands, (2) scale to include additional hardware components, (3) connect to external sources of data archival, and (4) integrate on-the-fly feedback from analytics into the control loop. Ultimately, the goal of any such system is to translate low-level commands to a high-level interface, allowing the researcher or operator to focus on high-level experiment design and execution. This goal does not mean that the researcher should be ignorant of the underlying operation of the instrument; rather, it acknowledges that most experiments aim to collect physically meaningful materials and chemical descriptors (e.g., morphology, texture, and local density of states), rather than raw (meta)data information (e.g., stage coordinates, probe current, and detector counts).

Alongside practical low-level instrument control, decision-making analytics is an additional important part of any automation platform. Traditional instrument operation has been based on human-in-the-loop control, in which a skilled operator manually defines experiment parameters, collects data, and evaluates outputs to decide next steps. However, this approach is poorly suited to the large data volumes and types now routinely generated; humans have difficulty analyzing higher dimensional parameter spaces, are prone to bias and omission of steps, and often cannot respond fast enough. Analytics approaches must therefore be employed that can quickly define actionable metrics for closed-loop control. The field of computational imaging has developed approaches to both improve data quality, such as denoising and distortion correction, and extract information, using methods such as component analysis and ML. Deep learning approaches, such as convolutional neural networks (CNNs), have grown in popularity in microscopy because of their ability to learn generalizable models for trends in data without a priori knowledge of underlying physics. These methods can effectively interrogate large volumes of data across modalities and can be accelerated using embedding computing hardware to reduce processing times. Among its many applications, ML has been used to effectively quantify and track atomic-scale structural motifs, and has shown recent successes as part of automated microscope platforms. Despite these benefits, traditional CNNs are typically constrained, since they typically require large volumes (100 to >10 k images) of tediously hand-labeled or simulated training data. Due to the wide variety of experiments and systems studied in the microscope, such data is often time-consuming or impossible to acquire. In addition, a training set is typically selected with a predetermined task in mind, which is difficult to change on-the-fly to incorporate new insights obtained during an experiment.

Recently, few-shot ML has been proposed as an alternative approach to learn novel visual concepts based on little to no prior information about a system. Few-shot is part of the broader field of sparse data analytics, which addresses the challenge of ML with limited data. In disclosed few-shot approaches (discussed above), offline CNN pre-training can be performed once using a typical network, such as ResNet101, followed by an online application of a few-shot meta-learner specialized using a limited number of examples provided by a user. These approaches have the benefit of computational efficiency, as examples can leverage offline training which can be performed as few as only one time, and flexibility to adapt to different tasks. Few-shot has seen minimal usage within the materials science community, primarily in the analysis of electron backscatter diffraction (EBSD) patterns, but it has great potential to inform triaging and classification tasks in novel scenarios. The disclosed few-shot techniques discussed herein have recently demonstrated the efficacy and flexibility for segmentation of electron microscope images. Using just 2-10 user-provided examples in a graphical user interface (GUI), it is possible to quickly classify microstructural features in both atomic-resolution and lower-magnification images. The output of the few-shot approach can include feature maps and statistics on the relative abundance of different features. Also, it is possible to easily extract pixel coordinates for desired features, which offers a pathway to feedback in a closed-loop automation system and/or form multi-modal support sets or enhance analysis of multiple different detection modalities.

Examples of disclosed automation platforms for various electron microscopes and other microscopes and instruments can be based on closed-loop feedback informed by few-shot ML. In some examples, instrument data can be acquired automatically according to a predefined search pattern through a central instrument controller. In some examples, the data can be passed to an asynchronous communication hub, where it is processed by a separate few-shot application based on user input. The processed data can be used to identify desired features associated with the data and to guide the subsequent steps of the experiment. In selected examples, in combination with a stage montaging algorithm, automated data collection can be performed over large regions of interest (ROIs). A particular advantage of the few-shot approach is that it can classify features and guide the system by task, which can be changed on-the-fly as new knowledge is gained. Disclosed approaches can lead to more intelligent and statistical experimentation in a variety of modes.

The design of any microscope control system is by its nature complex, since hardware components from multiple vendors must be networked to a custom controller and analysis applications. Some example systems can be divided into three subsystems: operation, control, and data processing. The operation system can include a programming language and communication network that translates complex, low-level hardware commands to a simple, high-level user interface. The control system can encompass open- and/or closed-loop data acquisition modes, based on few-shot ML feature classification. Where the operation system translates hardware commands, the control system translates raw data into physically meaningful control set points. Example operation is described herein in the context of statistical analysis of MoO₃ nanoparticles. In some examples, the data processing system can include on-the-fly and post hoc registration, alignment, and stitching of imaging data. Example architectures can enable flexible, customizable, and automated operation of a wide range of microscopy experiments.

As a platform backbone, representative examples can include a distributed operation system configured to acquire image data in an open-loop fashion, analyzing that data via few-shot ML, and then optionally automatically deciding on the next steps of an experiment in a closed-loop fashion. The distributed nature of the system allows for analysis execution on a separate dedicated ML station (e.g., remotely or using a cloud-based environment, and which can be optimized for parallel processing), acquisition and control of various instruments in a remote lab, and visualization of the process from the office or home. Example systems configured to provide remote visualization stand in contrast to remote operating schemes, which can suffer from latency and communication drop-outs that impact reliability.

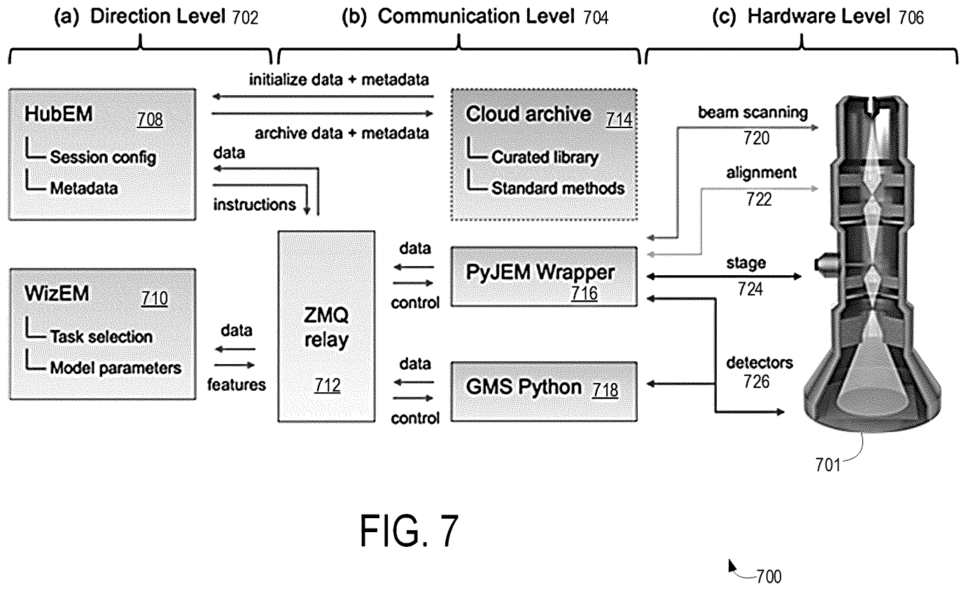

FIG. 7 shows an example operation system 700 for an electron microscope 701 arranged in three levels: a Direction Level 702, Communication Level 704, and Hardware Level 706. In representative examples, the Direction Level 702 includes a data acquisition application 708 and a few-shot machine learning application 710, configured to provide overall operation and few-shot ML analysis, respectively. The applications 708, 710 are the primary tools used by the end-user to interact with the microscope once a sample has been loaded and initial alignments have been performed. Each of the applications 708, 710 can be a separate process and may run on separate machines where practical. The data acquisition application 708 can be the main data acquisition application though other applications can be coupled to it. The data acquisition application 708 can be configured to send instructions, such as session configuration information, to instrument controllers, receives data from the instrument controllers, and store the data/metadata associated with a given experiment. The data acquisition application 708 passes instrument data to few-shot machine learning application 710 for few-shot ML analysis and receives analyzed data back for storage and real-time visualization. In some examples, the few-shot machine learning application 710 can feature a web-based Python Flask GUI. The few-shot machine learning application 710 is used to classify features in images or other instrument data groups based on user-defined few-shot support sets and record the quantity and coordinates of the classified features. The results of the analysis can be displayed to the user at the end of an open-loop acquisition or used as the basis for closed-loop decision making, as described further below.

The Communication Level 704 can be configured to connect the end-user applications to low-level hardware commands. For example, the Communication Level 704 can be specifically configured to minimize the amount of direct user interaction with multiple hardware subsystems, a process that can be slow and error-prone in more traditional microscope systems. Communications between various parts of the system 700 can be handled by a central messaging relay 712. In representative examples, the central messaging relay can provide asynchronous communication. In some examples, the central messaging relay 712 can be implemented in ZeroMQ (ZMQ), a socket-based messaging protocol that has been ported to many software languages and hardware platforms. The ZMQ publisher/subscriber model can be advantageous because it allows for asynchronous communication; that is, a component of the system 700 can publish a message and then continue with its work. For instance, the data acquisition application 708 can publish an image on a port to which the few-shot machine learning application 710 subscribes. The data acquisition application 708 can continue its work of controlling images, storing and visualizing data, while periodically checking the few-shot machine learning application 710 port it subscribes to. Conversely, the few-shot machine learning application 710 code can listen for any messages from the data acquisition application 708 via the ZMQ relay, as these messages will contain the image to be processed by the few-shot machine learning application 710. In the same message, the data acquisition application 708 can send the necessary parameters for few-shot analysis, such as the required chip size and the identity of the chips (microstructural features) assigned to each class in the support set or sets. Alternatively, a user may indicate these same parameters within the GUI at the start of, or at a key transition point in an experiment. In some examples, the output from the few-shot analysis can be the processed image (e.g., with each grid in the image colored by classification), the coordinates of each classified feature, and/or summary statistics for display in the data acquisition application 708. The few-shot machine learning application 710 can send the few-shot analysis output back to the ZMQ relay 712, where it can be acted on by the data acquisition application 708 when resources are available. The data acquisition application 708 can be further connected to one or more cloud archives 714. Data and methods, such as few-shot support sets and model weights, can be initialized prior to an experiment and then uploaded at the conclusion of an experiment.

The Hardware Level 706 has typically been the most challenging to implement because direct low-level hardware controls are often unavailable or encoded in proprietary manufacturer formats. While many manufacturers have offered their own scripting languages, these are usually inaccessible outside of siloed and limited application environments, which are incompatible with open Python or C++/C#-based programming languages. However, the recent release of APIs such as PyJEM 716 and Gatan Microscopy Suite (GMS) Python 718 has unlocked the ability to directly interface with many instrument operations, including beam control 720, alignment 722, stage positioning 724, and detectors 726. A wrapper to define higher level controls can be provided for each of these APIs which are then passed through the ZMQ relay 712. The Hardware Level 706 can be configured to be modular and can be extended through additional wrappers as new hardware is made accessible or additional components are installed. Together, the three levels 702, 704, 706 of the operation system 700 serve to translate the control of the microscope, linking it to rich automation and analysis applications, e.g., via an asynchronous communications relay.

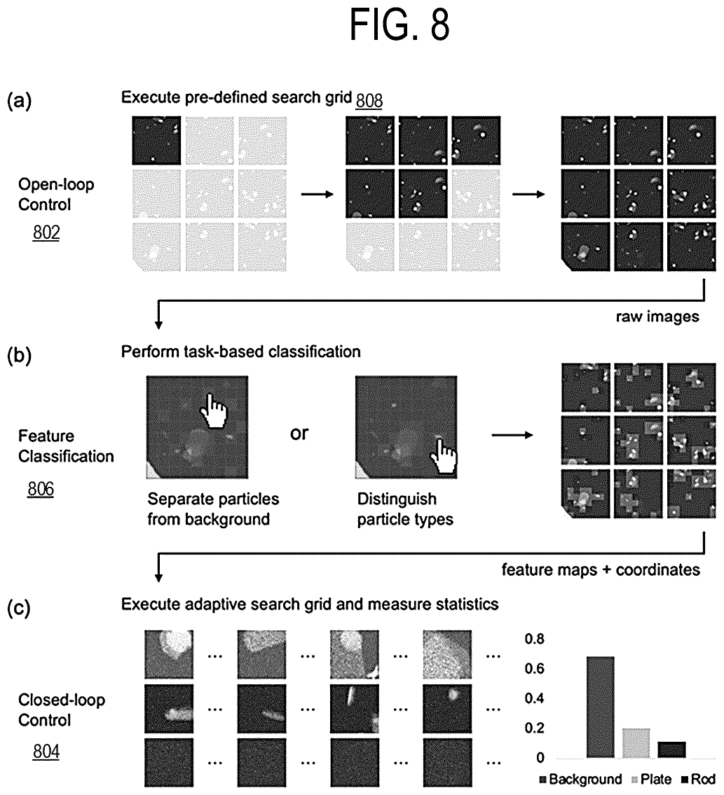

FIG. 8 shows various instrument control modes that can be used for the operation system 700. In some examples, instruments can be run under open-loop control 802 or closed-loop control 804, separated by a process of feature classification 806. In open-loop control operation, a system can execute a pre-defined search grid 808 based on parameters provided by a user in a data acquisition application or downloaded from a cloud repository. Execution of a pre-defined search grid based on parameters provided by a user in a data acquisition application can be particularly useful in a novel scenario, e.g., when a user is unsure of what a sample contains. Execution of a pre-defined search grid based on parameters provided received from external source, such as a cloud repository, may be useful in large-scale screening campaigns of the same types of samples or features. An advantage of the disclosed approaches is that sampling methods can easily be standardized and shared among different instrument users or even among different laboratories or industrial environments.

As data is acquired via open-loop control 802, it is passed to a few-shot machine learning application for feature classification 806, e.g., through the ZMQ relay 712 shown in FIG. 7. The support set and model parameters for few-shot analysis can be initialized from a cloud source or dynamically adjusted in an interactive GUI, as described herein. During feature classification 806, the user can select one of the first few acquired frames containing microstructural features of interest. An adjustable grid is dynamically super-imposed on the image, and the image is separated at these grid lines into squares or other area shapes, which can be referred to as chips (as discussed above), some of which are subsequently assigned by the user into classes to define few-shot support sets. Using as few as 2-10 chips as examples for each support set, the few-shot application can run a few-shot python script on some or all the subsequent images sent by the data acquisition application. Each chip in each image can be classified into one of the classes indicated in the support sets. The few-shot machine learning application incorporated into the graphical user interface application can send the colorized segmented images, class coordinates, and summary statistics back to the data acquisition application for display to the user.

After the user has defined features of interest for the few-shot analysis, the instrument can be operated in the closed-loop control mode 804. In closed-loop control 804, the initial search grid is executed to completion according to the user's initial specifications. The user pre-selects feature types to target in a follow-up analysis, which can be referred to as an adaptive search grid. After the initial few-shot ML analysis is performed on the selected frames, the type and coordinates of each feature are identified and passed back to the data acquisition application. The system can then adjust parameters such as stage coordinates (including movement stages), magnification, sampling resolution, current/dose, beam tilt, alignment, and/or detectors to automatically adaptively sample desired feature types.

To illustrate a real-world example of instrument control, nanoparticle analysis can be considered as a suitable use case. A sample of molybdenum trioxide (MoO₃) flakes was selected, because it exhibits a range of particle sizes, orientations, and morphologies. MoO₃ is an important organic photovoltaic (OPVs) precursor, and has shown promise in preventing antimicrobial growth on surfaces, and, when reduced to Mo, can provide corrosion resistance to austenitic stainless steels. The TEM sample selected has traditionally been utilized to calibrate diffraction rotation. For diffraction rotation calibration, small, electron transparent platelets of varying dimension (100 s of nm to μm) are evaporated onto a carbon film TEM grid.

As shown in the top of FIG. 8, the user first acquires a pre-defined search grid within the data acquisition application. The search grid can be collected with specific image overlap parameters and knowledge of the stage movements to facilitate post-acquisition stitching, as discussed further below. The observed distribution and orientation of the particles includes individual platelets lying both parallel and perpendicular to the beam (termed “rod” and “plate,” respectively), as well as plate clusters. Particle coordinates and type can then be measured automatically via few-shot ML analysis. To do this, the initial image frames in the open-loop acquisition are passed through the ZMQ relay for asynchronous analysis in the few-shot machine learning application. The user selects examples of the features of interest according to a desired task, which is a significant advantage of the few-shot approach over other machine learning approaches. For example, the few-shot model can be tuned to distinguish all particles from the background or to separate specific particle types (e.g., plates and rods) by selecting appropriate support sets. Significantly, this task can easily be adjusted on-the-fly or in post hoc analysis as new information is acquired. Using this information, image segmentation, colorization, and statistical analysis of feature distributions is performed on subsequent data as the open-loop collection proceeds. This information can be passed back to the data acquisition application, where it can be presented dynamically to the user. In the final mode of closed-loop operation, various system parameter adjustments can be made. For example, the stage can drive to specific coordinates of identified particles, magnification can be adjusted, and/or acquisition settings can be adjusted such as beam sampling or detector type or mode of operation. Such adjustments are often the most challenging part of an experiment, because since they rely on precise recall of stage position and stability of instrument alignment. Closed-loop control can be applied at both lower and higher magnifications. At higher magnification, the stage is far more susceptible to mechanical imprecision and focus drift, which can require considerably more feedback in the control scheme.

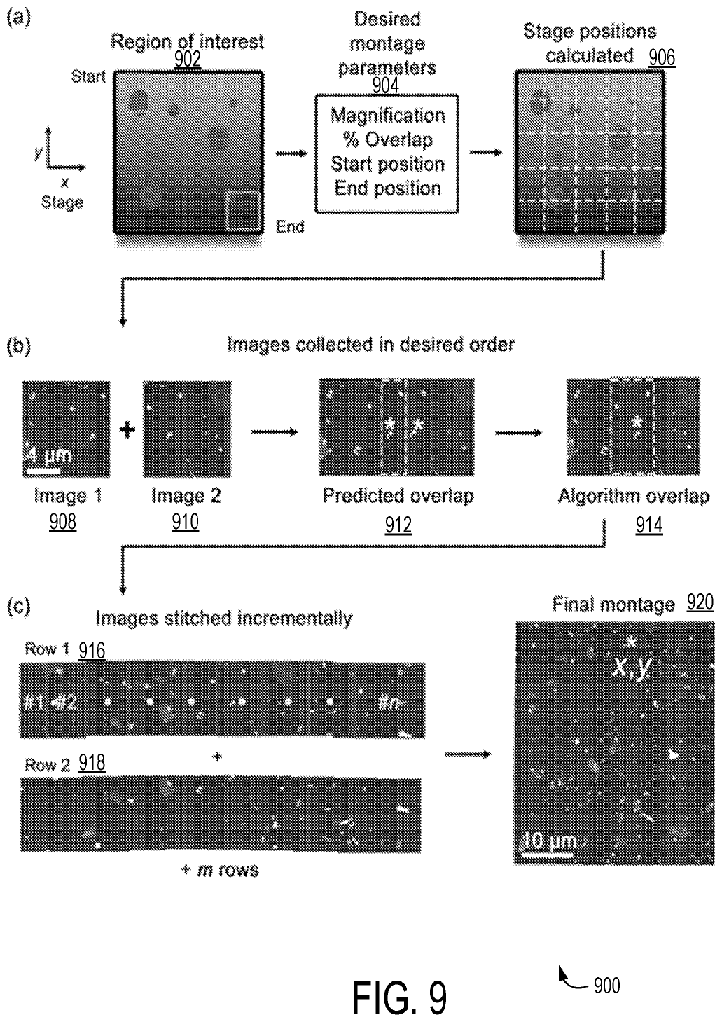

Alongside the operation and control systems already described, a data processing system can be provided for large-area data collection, registration, and stitching of images. This processing can be important to orient the user to the global position of local microstructural features and can be beneficial in both closed-loop control and accurate statistical analysis. Building on the MoO₃ example discussed above, steps in a suitable data acquisition process are shown in FIG. 9. While such a sample is suitable because it contains different particle morphologies and orientations, it is also challenging to analyze because of the sparsity of those particles (i.e., large fraction of empty carbon background). FIG. 9 shows an example montaging method 900 that can be used to perform data acquisition at lower magnification, which can be useful for overlapping adjacent images in the x and/or y stage direction and which may be particularly applicable for particle sparsity. The montaging method 900 includes having the user select a single region of interest (ROI) 902 within the Cu TEM grid with no tears and a high density of particles, as shown by closed circles representing a desired feature on a support grid. This ROI is typically selected at lower magnification to increase the overall field of view (FOV) but may also be selected at higher magnification. Alternatively, fiducial markers, such as the corners of a finder grid, may be used to define the ROI 902. In either case, the x and y coordinates at the opposite corners of the ROI 902 are defined as the collection Start and End positions, respectively.

Upon selection of the desired ROI, the user can be prompted to enter montage parameters 904, such as both the magnification and the desired percent overlap between consecutive images in the montage. Combined with the Start and End positions, the number of maps as well as the stage coordinates of each individual image to be collected is calculated at 906 by dividing the area of the ROI based on the overlap and image size. Depending on user preference, the system can collect each image in a serpentine fashion or a sawtooth-raster search pattern. A serpentine pattern can start in an upper left corner (or another corner) and can move in a selected direction (e.g., to the right) until reaching a row end (nth frame). Then, the image acquisition would move down one row and traverse back towards the left, repeating this process row-by-row until the mth row is reached and the montage is complete. A z-raster pattern can start in the upper left and move to the right until reaching the end of the row, similar to the serpentine pattern. At the end of the row, the image capture would move down one row and all the way back to the left. From a montaging and image processing perspective, there is little practical difference between the two methods, so the reduced travel time of the serpentine method is typically preferred. Upon starting the montaging capture method 900, the program can collect the first image 908 (Image 1), at which time the feature classification process shown in FIG. 8 can be used to delineate desired features. Upon choice of initial classification schemes, a second image 910 is acquired (Image 2) and the method 900 utilizes predicted overlap coordinates 912 to perform an initial image alignment check 914. A montaging algorithm, explained further below, is employed for further refinement of the relative displacement between the two images 908, 910 needed for feature alignment. As shown in the predicted overlap 912 frame, the same particles, indicated with asterisks, are observed in each image, but are not overlapped with one another. When further refinement of the montaging algorithm is applied in 914, the particles overlap, again indicated by the red asterisk. Upon completion of a first row 916 (Row 1), the second row 918 (Row 2) is collected until n rows of data have been captured and the End position has been reached. While shown in FIG. 9 as complete rows, during operation each image can be montaged to previous data collected in real-time. After all stage positions have been imaged, a final montage 920 can be calculated, at which time the user has the option to manually or automatically select a region of interest (e.g., the particles denoted by the asterisk) in order for the microscope to drive to the desired position and magnification.

When montaging is based solely on image capture, especially over large areas, there are many potential complications that can affect the final stitched montage. Depending on the scanning transmission electron microscopy (STEM) conditions selected, beam drift can push the scattered diffraction discs closer to a given detector (e.g., strong diffraction onto a dark-field detector) that can skew imaging conditions from the first to the last image collected. As already mentioned, particle sparsity or clustering within the ROI can also present difficulties. For example, if the magnification is set too high, there may be regions within adjacent areas that have no significant contrast or features for registration. Such a situation might be encountered in large area particle analysis as well as in grain distributions of uniform contrast. Stage motion can significantly affect outcomes where there is a mismatch with predicted image position. Image timing also can significantly affect stitching efforts, e.g., if the stage is moving during image capture, images can become blurred. Further, if the area of interest is too large, sample height change can affect the image quality due to large defocus.

In view of these difficulties, various image stitching approaches have been evaluated based on knowledge of the stage motion, as well as those solely based on image features. In some examples, prediction based on stage motion can be used to calculate the overlap between two images directly, though artifacts in the stitched image may be present due to a variety of practical factors related to stage movement and image acquisition. For example, in some instances, motor hysteresis or stage lash causes a stage movement command to deviate from an issued command An example of where the “Predicted overlap” fails to accurately stitch adjacent images is shown at frame 912. Image-by-image corrections can therefore be performed post hoc using either manual or automated approaches. Manual stitching works well for small numbers of images because the human eye is good at detecting patterns. However, such a process is time intensive, does not scale well to large montages, and cannot be automated within a program for automatic acquisition. To automate this process, several standalone software packages are available but do not provide the user with immediate feedback while directly interfacing with the microscope. As part of the processing system, an image-based registration script can be provided to dynamically align and stitch images during an acquisition. The algorithm 914 computes the cross correlation of adjacent images quickly using the Convolution Theorem, e.g., as implemented in SciPy's signal processing library, and then identifies the peak of the cross correlation to find the correct displacement for maximum alignment. From this normalized cross correlation, the best alignment is found from a the local maximum closest to predicted overlap, as shown in the frame 914. This alignment process then repeats for every image as it is acquired to build up the overall montage 920. After processing the raw images, the same corrections can be applied to the few-shot classified montage, providing the user with a global survey of statistics on feature distributions in their sample.

In an embodiment, stitching was performed using a custom Python 3.7.1 script which can be run locally as a library or run as a stand-alone application on a remote machine to gain more processing power. In some examples, the acquired images were converted to grayscale to remove redundant information. Then, the images were normalized to have mean pixel intensity of 0 and the maximum of the absolute value of intensity was normalized to 1 to adjust for differences in illumination or contrast. The cross correlation of the two images was then computed for every possible overlap between them. While it is not computed this way for efficiency purposes, intuitively the cross correlation can be thought of as sliding one image over the other and pointwise multiplying the pixel values of the overlapping points and then summed Larger values of the cross correlation correspond to better agreement in the features of the two images because similar values, either positive or negative, will square to positive contributions. If the values are dissimilar, (e.g., a mixture of positive and negative values), then they tend to cancel out which leads to smaller values that indicate worse agreement. As such, this computed value is used to search the possible overlaps to find a local maximum. However, there is subtlety in how this maximum is determined because if the image shows periodic structure, then there could be many local minima in the cross correlation. In general, the global maximum typically occurs when the images are almost completely overlaid because there are lots of pixels that are being summed, even if the overall alignment is poor. To compensate for this effect, and to emphasize the fact that we are prioritizing alignment, the cross correlation is normalized by the number of pixels that were summed to compute the value.

Thus, example automation systems can combine low-level instrument control with closed-loop operation based on few-shot ML. Systems can provide practical translation of low-level hardware components from multiple manufacturers, which can be easily programmed through intuitive GUI applications by the end-user. Microscope operation in both open-loop and closed-loop fashions can be provided, permitting facile statistical analysis of samples by task, in contrast to more traditional automation approaches.

The physical microscope hardware used in some described experiments is a probe-corrected JEOL GrandARM-300F scanning transmission electron microscope (STEM) equipped with the pyJEM Python API. The data shown is acquired in STEM mode at 300 kV accelerating voltage. Data processing is performed on a separate remote Dell Precision T5820 Workstation equipped with a Intel Xeon W-2102 2.9 GHz processor and 1 GB NVIDIA Quadro NVS 310 GPU.

Operation systems include individual software components that operate on different hardware components. Software examples were implemented in C#/Python and uses Python.NET, a library that allows Python scripts to be called from within a .NET application. Stitching software applications used a Python library to stitch images together to form a montage. As with other described applications, stitching software applications can be run locally as a library or run as a stand-alone application on a remote machine to gain more processing power. PyJEM Wrapper is an application that wraps the PyJEM library allowing communication to the TEM Center EM control application from JEOL. The PyJEM Wrapper is written in Python and runs on the PC that used to control the EM. Gatan Scripting allows communication to the Gatan Microscopy Suite (GMS) control software. It runs as a Python script in the GMS embedded script engine. All components communicate with a central data acquisition application using a protocol based on ZeroMQ and implemented in PyZMQ. It uses the ZMQ publisher/subscriber model which makes it asynchronous. All python components are multi-platform and have been tested on Windows, Linux, and Mac OS.

Few-shot machine learning application examples integrate Python, D3, JavaScript, HTML/CSS, and Vega-lite with Flask, a Python web framework. The front-end interactive visualization was created with JavaScript and HTML/CSS. The Flask Framework allows the inputs from the front-end user interaction to be passed as input to the Python scripts on the back-end. The Python scripts include the few-shot code for processing the image and the few-shot machine learning code for receiving the image and sending back the processed image.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

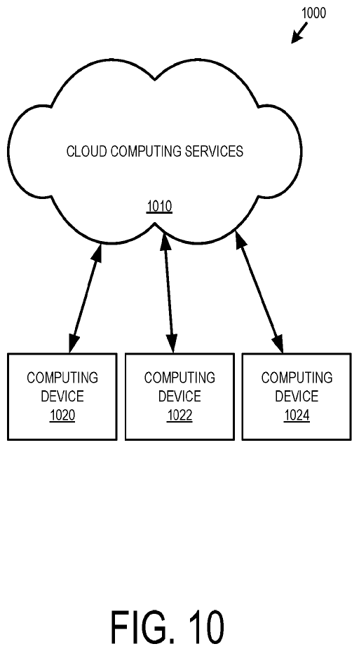

FIG. 10 depicts an example cloud computing environment 1000 in which the described technologies can be implemented. The cloud computing environment 1000 includes cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries). The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices, including those part of or connected to microscope apparatus or other instruments. For example, the computing devices (e.g., 1020, 1022, and 1024) can utilize the cloud computing services 1010 to perform computing operators (e.g., data processing, data storage, and the like).

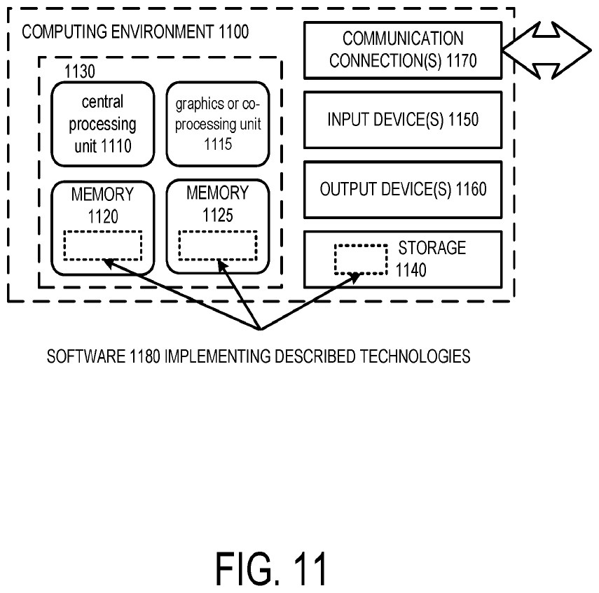

FIG. 11 depicts a generalized example of a suitable computing system 1100 in which the described innovations may be implemented. The computing system 1100 is not intended to suggest any limitation as to scope of use or functionality of the present disclosure, as the innovations may be implemented in diverse general-purpose or special-purpose computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing components of the computing environments of, or providing the data (e.g., microscope image) outputs shown in, FIGS. 1-10, described above. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 may be removable or non-removable, and includes magnetic disks, magnetic tapes or cassettes, CD-ROMs, DVDs, or any other medium which can be used to store information in a non-transitory way and which can be accessed within the computing system 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing system 1100. The output device(s) 1160 may be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Described algorithms may be, for example, embodied as software or firmware instructions carried out by a digital computer. For instance, any of the disclosed few-shot machine learning, automation, and montaging techniques can be performed by one or more a computers or other computing hardware that is part of a data acquisition system. The computers can be computer systems comprising one or more processors (processing devices) and tangible, non-transitory computer-readable media (e.g., one or more optical media discs, volatile memory devices (such as DRAM or SRAM), or nonvolatile memory or storage devices (such as hard drives, NVRAM, and solid state drives (e.g., Flash drives)). The one or more processors can execute computer-executable instructions stored on one or more of the tangible, non-transitory computer-readable media, and thereby perform any of the disclosed techniques. For instance, software for performing any of the disclosed embodiments can be stored on the one or more volatile, non-transitory computer-readable media as computer-executable instructions, which when executed by the one or more processors, cause the one or more processors to perform any of the disclosed techniques or subsets of techniques. The results of the computations can be stored in the one or more tangible, non-transitory computer-readable storage media and/or can also be output to the user, for example, by displaying, on a display device, image segmentations with a graphical user interface.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims

1. A computer-implemented method, comprising:
sectioning at least a portion of a real data set of interest into a grid of chips, each chip comprising a real data subset of the portion of the real data set of interest, and receiving a few user-selected chips corresponding to ground truth examples selected from the portion of the real data set, wherein the selected chips define a support set for a few-shot class prototype;
encoding a latent space representation of the support set using an embedding neural network, and defining the few-shot class prototype as a mean vector of the latent space representation of the support set; and
using the embedding neural network, encoding a latent space representation of other chips of the real data set of interest, and, using a few-shot neural network, comparing the latent space representation of the other chips to the few-shot class prototype and assigning few-shot class prototype labels to the other chips based on the comparison to identify features in the real data set of interest that are similar to the few user-selected chips.

2. The method of claim 1, wherein the encoding the latent space representation of the support set comprises transforming the support set data, having D-dimensionality, into the latent space representation, having an M-dimensionality, through an embedding function f(φ) having learnable parameters φ.

3. The method of claim 2, wherein the support set S for the class prototype k is S={(x₁; y₁); . . . (x_{N}; y_{N})} where xᵢ represents a chip i and y i is the corresponding true class label, the transforming with the embedding function produces transformed chips through ƒφ(xᵢ)=zᵢ, and the mean vector comprising embedded support points for the class prototype k is defined by:
$${c}_{k} = \frac{1}{{N}_{{S}_{k}}} {\sum }_{( {z}_{i} , {y}_{i} ) ∈ {S}_{k}} {z}_{i}$$

4. The method of claim 1, wherein the comparing the latent space representation of the other chips to the few-shot class prototype and assigning few-shot class prototype labels to the other chips based on the comparison comprises, for each other chip:
calculating a Euclidean distance between the latent space representation of the chip and the few-shot class prototype;
normalizing the distance into class probabilities using a softmax; and
assigning the few-shot class prototype label to the chip where the few-shot class prototype label has a highest class probability.

5. The method of claim 1, further comprising applying label smoothing by weighting a class probability associated with a chip based on labeling of nearby chips.

6. The method of claim 1, further comprising applying label smoothing by adjusting the chips that define the support set.

7. The method of claim 1, wherein the real data set comprises one or more images and the grid of chips comprises a grid of sub-images.

8. The method of claim 7, further comprising estimating a total area of a feature type in the one or more images based on a percentage and area of chips assigned with the few-shot class prototype label.

9. The method of claim 1, wherein the embedding neural network is an off-the-shelf neural network pre-trained on a data set related or unrelated to the real data set of interest.

10. The method of claim 1, wherein the few user-selected chips comprises greater than or equal to one and less than or equal to ten user-selected chips.

11. The method of claim 1, further comprising receiving another few user-selected chips corresponding to ground truth examples selected from the real data set, wherein the few additional selected chips define a second support set for a second few-shot class prototype, defining a second few-shot class prototype using the second support set, and comparing the latent space representation to the second few-shot class prototype and assigning second few-shot class prototype labels to chips based on the comparison to identify features in the real data set of interest that are similar to the additional few user-selected chips.

12. The method of claim 1, receiving another few-numbered set of user-selected chips corresponding to ground truth examples selected from the real data set in response to the assignment of the few-shot class prototype labels, wherein the selected chips of the additional few-numbered set of user-selected chips define a support set for another few-shot class prototype.

13. The method of claim 12, wherein the selected chips the additional few-numbered set of user-selected chips comprise an adjustment to the previous selection of few user-selected chips.

14. The method of claim 1, wherein the real data set of interest comprises a real data set that changes over time, and further comprising after the defining of the few-shot class prototype adding a new few-shot class prototype or modifying the few-shot class prototype, based on data obtained at a later time sequence or during data acquisition.

15. The method of claim 1, wherein the real data set of interest is acquired according to a first detection modality, the method further comprising assigning the few-shot class prototype labels to similar chips of a second real data set of interest associated with a second detection modality.

16. The method of claim 1, further comprising defining one or more of the similar chips having the assigned few-shot class prototype labels as a second support set for a second few-shot class prototype associated with a second detection modality.

17. The method of claim 1, wherein the real data set of interest is acquired according to a first detection modality, the method further comprising:
receiving a second set of few user-selected chips corresponding to ground truth examples selected from a portion of a second real data set associated with a second detection modality, wherein the selected chips define a second support set;
wherein the few-shot class prototype is an aggregate few-shot class prototype defined in relation to latent space representations of the support set and the second support set;
wherein the using the few-shot neural network includes comparing latent space representations of other chips of the real data set of interest and the second real data set of interest to the aggregate few-shot class prototype and assigning aggregate few-shot class prototype labels to the other chips of the real data set of interest and the second real data set of interest based on the comparison to identify features in the real data set of interest and the second real data set of interest that are similar to the support set and the second support set.

18. The method of claim 17, further comprising combining the real data set of interest and the second real data set of interest before using the few-shot neural network to form an early fusion data set.

19. The method of claim 17, wherein the few-shot neural network comprises separate sub-networks each configured to label respective real data sets based on the respective support sets, the method further comprising combining the outputs of the sub-networks to form a late fusion output.

20. The method of claim 1, further comprising automatically adaptively sampling desired feature types by adjusting data acquisition parameters and acquiring another real data set at chip locations having an assigned few-shot class prototype label.

21. The method of claim 20, wherein the automatically adjusting data acquisition parameters includes adjusting an imaging system movement stage, an imaging system magnification, an imaging system sampling characteristic, an imaging system detector, or an imaging system detector selection.

22. A microscope system, comprising:
memory, one or more processing units coupled to the memory, and one or more non-transitory computer readable storage media storing instructions that, when executed, cause the microscope system to perform operations between at least an operation subsystem and a control subsystem, the performed operations comprising:
through the operations subsystem, directing acquisition of microscope instrument data in response to user inputs and analyzing the acquired microscope instrument data with a few-shot neural network using direction, communication, and hardware levels, wherein the direction level comprises a user-level interface with data acquisition and few-shot machine learning applications; and
through the control subsystem, acquiring data through at least an open-loop control mode including superimposing an adjustable grid on a user-selected frame of microscope instrument data containing features of interest with the grid separating the image at grid lines into area shapes and with user-selected area shapes defining few-shot support sets for the few-shot machine learning application, wherein the few-shot machine learning application is configured to analyze the user-selected frame and other frames of microscope instrument data sent by the data acquisition application by applying grids to the frames and by classifying each area shape in the acquired data into one of the classes associated with the few-shot support sets.

23. The microscope system of claim 22, wherein the performed operations include, through the control subsystem:
acquiring data through a closed-loop control mode including forming an adaptive search grid based on coordinates of few-shot classifications obtained through the open-loop mode; and
adjusting data acquisition parameters to automatically sample pre-selected feature types using the adaptive search grid.

24. The microscope system of claim 23, wherein the adjusting data acquisition parameters includes adjusting parameters of a stage, imaging magnification, sampling resolution, current/dose, beam tilt, alignment, and/or detectors.

25. The microscope system of claim 22, wherein the microscope system comprises a transmission electron microscope, a scanning electron microscope, a scanning-transmission electron microscope, or an optical microscope.

26. The microscope system of claim 22, further comprising:
acquiring images over a selected region of interest based on a set of stage parameters including a percentage overlap between acquired images; and
stitching images together to form an image montage over the region of interest based on (i) image positions associated with the stage parameters and (ii) a correction for misalignment of adjacent images associated with a peak of a cross correlation of the adjacent images.

27. A computer-implemented method, comprising:
sectioning at least a portion of a real data set of interest into a grid of chips, each chip comprising a real data subset of the portion of the real data set of interest, and receiving a few user-selected chips corresponding to ground truth examples selected from the portion of the real data set, wherein the selected chips define a support set for a few-shot class prototype; and
receiving and/or displaying an identification of features in the real data set of interest that are similar to the few user-selected chips, wherein the identification is produced by:
encoding a latent space representation of the support set using an embedding neural network, and defining the few-shot class prototype as a mean vector of the latent space representation of the support set; and
using the embedding neural network, encoding a latent space representation of other chips of the real set data set of interest, and, using a few-shot neural network, comparing the latent space representation of the other chips to the few-shot class prototype and assigning few-shot class prototype labels to the other chips based on the comparison.
